(19) United States
(12) Patent Application Publication
(10) Pub. No.: US 2009/0069728 A1
(43) Pub. Date: Mar. 12, 2009

(54) Randomic vibration for treatment of blood flow disorders

(76) Inventors: Andrew Kenneth Hoffmann, Burnaby (CA); Carlo Menon, Burnaby (CA)

Correspondence Address: LAURENCE C. BONAR, 917 LOGAN ST, PORT TOWNSEND, WA, 98368-2337, US

(21) Appl. No.: 12/291,128

(22) Filed: Nov. 5, 2008

Related U.S. Application Data
(63) Continuation-in-part of application No. 12/218,054, filed on Jul. 11, 2008.
Application No. 12/218,054 is a continuation-in-part of application No. 11/036,386, filed on Jan. 18, 2005.
Application No. 11/036,386 is a continuation-in-part of application No. 10/902,122, filed on Jul. 30, 2004.

(51) Int. Cl. A61H 1/00

(52) U.S. Cl. 601/46

(57) ABSTRACT

A therapeutic device and method for use thereof for treatment of blood flow disorders is disclosed. In one embodiment, a first line emergency response system for treatment of acute thrombotic and/or vasospastic vascular obstructions via the noninvasive application of low frequency vibration with at least one, and preferably a plurality of randomly administered vibratory waveform characteristics (herein after “Randomic Vibration”) is detailed. The disclosed apparatus and methods are based on the intuition that transcutaneously imparted low frequency randomic vibration can provide enhanced clot disruption and mixing of clot disruptive agents to acutely thrombosed vessels, due to the addition of mechanical chaos via non-regular, multi-vectored convection currents. In a preferred embodiment, the disclosed apparatus and methods preferably utilize randomic vibration as an adjunct to systemically administered drug therapy, most preferably intravenously administered thrombolytic drug therapy.

### 1. RELATED APPLICATIONS

This application is a continuation-in-part of co-pending U.S. application Ser. No. 12/218,054 entitled “Percussion Assisted Angiogenesis” filed Jul. 11, 2008, which is a continuation-in-part and claims the benefit of co-pending U.S. application Ser. No. 11/036,386 entitled, “Hand Held Imaging Probe for Treatment of States of Low Blood Perfusion” filed Jan. 18, 2005, which is a continuation-in-part and claims the benefit of co-pending U.S. application Ser. No. 10/902,122 entitled, “Low Frequency Vibration Assisted Blood Perfusion Emergency System”, filed Jul. 30, 2004, which claims the benefit of priority document CA application no. 2,439,667, filed Sep. 4, 2003, entitled “Low Frequency Vibration Assisted Blood Perfusion Method and Apparatus”, the contents of all of which are expressly incorporated herein by reference.

### 2. TECHNICAL FIELD

This invention relates to improved noninvasive therapeutic vibration systems for treating blood flow disorders. More particularly, this invention relates to the use of externally applied vibration with randomly applied waveform characteristics to treat blood flow disorders, and yet more particularly to facilitate clearance of acute thrombotic vascular obstructions and to promote angiogenesis.

### 3. BACKGROUND OF THE INVENTION

Acute myocardial infarction and acute stroke (arterial thrombosis) comprise the leading killer and source of disability in the developed world, and early complete blood flow restoration to the affected artery is well established as the chief determinant of good clinical outcome. Current first line treatment of thromboses in the acute phase, when a catheter based unit—such as a cardiac cathlab or neurovascular special procedures unit—is not readily available, is typically by intravenous introduction of thrombolytics, or a combination of drugs such as heparin, aspirin and/or GP 2b 3a platelet inhibitors to dissolve the culprit blood clot. Intravenous and oral nitrates may also be introduced in order to dilate the culprit coronary or other vessel, which usually has a degree of spasm associated.

Low frequency mechanical vibration has recently been forwarded as a practical and convenient adjunctive treatment to thrombolytic or other clot disruptive or anti-ischemic drugs for remediation of acute arterial thrombosis and other blood flow disorders. The general idea is that low frequency vibro-percussion or agitation penetrates into the human body very effectively, and enhances mixing of a clot disruptive therapeutic agent into a zero or low flow thrombosed artery. Low frequency vibration is also known to have clot disruptive and vasodilatory properties, and causes liberation of beneficial mediators such as nitric oxide within the thrombosed blood vessels.

Sackner in US Patent Application 20020103454 discloses a whole body “reciprocating movement platform” or bed which oscillates in a rhythmic to and fro motion (i.e. in the head to foot direction), delivering “external pulses” to a human body in the frequency range of 0.25-6 Hz, for a plurality of applications including improving blood circulation in chronic and acute cases. The 454 patent application invokes hemodynamic forces or “pulses” by virtue of the accelerations and deceleration's of the movement platform which purportedly instill sheer stresses from blood to endothelium of the vasculature; which is known to invoke the liberation of endogenous “beneficial mediators” such as t-PA, EDRF, and Nitric Oxide (all of which are of assistance in the improvement of blood flow and prophylaxis to disease).

Horzewski in U.S. Pat. No. 7,229,423 discloses a low frequency chest wall vibration system operable in the 20 Hz-20 KHz range (preferably in the high KHz ranges) for treatment of acute myocardial infarction or stimulation of angiogenesis. A piezoelectric actuator is employed, enabling low amplitude micro displacements which cannot be felt by the patient.

Hoffmann in co-pending U.S. patent application Ser. No. 10/902,122 discloses a higher amplitude low frequency vibration system for applying localized low frequency vibration at a frequency in the range of 1-1000 Hz and a displacement amplitude in the range of 0.1-15 mm to the torso, neck or head of a patient, preferably as an adjunctive treatment to IV thrombolytic drug therapy in treatment of heart attack or acute ischemic stroke. A variety of waveforms, frequencies and displacement amplitudes are selectable according to the preference of the operator. Vibration can also be timed to the diastole of a cardiac cycle, which is known to cause a positive contractile effect to heart muscle, which is useful should the patient deteriorate into heart failure or cardiogenic shock during therapy.

Most recently, Hoffmann and Yohannes, in their article entitled, “Non-invasive Low Frequency Vibration as a Potential Adjunctive Treatment for Heart Attack and Stroke. An In-vitro Flow Model” published online in May, 2007 in the Journal of Thrombosis and Thrombolysis, report an in-vitro flow model experiment whereby localized vibration applied at a set frequency and amplitude (i.e. 100 Hz, 0.5 mm) across an attenuating medium assists clearance of a blood clot in a stenosed catheter system held at arterial like pressure.

While the low frequency vibration systems listed above are generally employable for treatment of acute blood flow disorders or assisting angiogenesis, none of the prior arts have employed a strategic vibratory algorithm specifically tailored to provide improved efficiency for treatment of blood flow disorders, including improved agitation, to disrupt and clear thrombosis and enhance mixing of a drug agent into a thrombosed vessel, nor to provide enhanced efficiency stimulation of the endothelium of vascular cells to induce angiogenesis. Methods and apparatus which provide improved transcutaneous low frequency vibration effectiveness in the treatment of blood flow disorders, such as acute thrombotic vascular obstructions, and in particular acute thrombotic arterial obstructions, as well as to stimulate angiogenesis are thereby required.

### 4. SUMMARY OF THE INVENTION

An embodiment of the present invention relates to a first line emergency response system for the treatment of blood flow disorders, especially acute thrombotic and/or vasospastic vascular obstructions, via the noninvasive application of low frequency vibration with at least one, and preferably a plurality of randomly administered vibratory waveform characteristics (hereinafter referred to as “Randomic Vibration”). As defined in this disclosure, the term “blood flow disorder” shall be understood to mean any type of acute or non-acute blood flow disorder, affliction, blockage or disruption, without limitation. An embodiment of the present invention is based on the intuition that external, transcutaneously imparted low frequency Randomic Vibration can with improved efficiency, due to the addition of mechanical chaos and non-regular, multi-vectored convection currents, enhance clot disruption and mixing of clot disruptive agents to treated acutely thrombosed vessels. The emergency response system optimally utilizes Randomic Vibration as an adjunct to systemically administered drug therapy, most preferably intravenously administered thrombolytic drug therapy. The application of Randomic Vibration is also highly useful in chronic therapy for induction of angiogenesis—whereby turbulent or chaotic hemodynamic vectors (or shear stresses) applied to the endothelial cells of coronary or other vasculature is a particularly potent stimulator in signaling new endothelial cells growth. Randomic Vibration may also be used for treatment of angina pectoris, wherein an acute coronary thrombosis cannot be ruled out.

A preferred embodiment of the invention relates to an emergency response system employing a low frequency Randomic Vibration device (or percussor by other name) designed to facilitate and improve the emergency treatment of acute ST elevation myocardial infarction (STEMI), by externally imparting high amplitude sonic to infrasonic randomic mechanical energy to the chest wall of a patient as an adjunct to systemically delivered thrombolytic therapy, (and/or any other form of drug therapy). A noninvasive vibrator comprising a vibration source with an attachment interface (to enhance transmission and/or effectiveness of emitted vibration—exemplary attachment interfaces disclosed by Hoffmann in U.S. patent application Ser. No. 10/902,122, and are herein incorporated by reference), enables high amplitude low frequency external vibration to optimally penetrate to the heart, with or without a skilled imaging technique, and thereby synergistically facilitate the action of systemically administered drug therapy by providing an optimized agitative response to the culprit coronary circulation. Agitation of the epimyocardium by Randomic Vibration stimuli, and hence the coronary arteries, will improve (by way of chaotic sonic streaming, multi vectored sheer forces and cavitation) the mixing of systemically introduced drugs down an otherwise zero flow, or low flow vascular system.

Mechanically delivered Randomic Vibration further induces disruption of clots which leads to increased permeation of drugs into the clots, and also low frequency Randomic Vibration independently results in a localized coronary vasodilatory response to the culprit circulation which often has a degree of spasm associated.

A practical emergency response system employing a non-invasive low frequency mechanical randomic vibrator, optimally employable in conjunction with systemically delivered drug therapy and operational preferably in the low frequency ranges (i.e. 1-1000 Hz range), which is specifically designed and suited to assist the localized process of coronary thrombotic disruption and thrombolysis (and relief of coronary spasm if associated) in the particular emergency treatment of Acute Myocardial Infarction, is disclosed according to an embodiment of the invention

The provided system is further adaptable to assist clot disruption and systemically delivered drug therapy and effectiveness localized to other body regions experiencing an acute state of low blood perfusion, such as in acute vascular obstructions to the cerebral, pulmonary and peripheral vasculature.

Randomic Vibration of a clot disruptive drug improves diffusability and penetrability of said drug, such as to enable a synergistic system of Randomic Vibration assisted drug delivery. Randomic Vibration adds mechanical chaos into a thrombosed artery, hence assisting mixing and agitation of a thrombosis and clot disruptive agent with improved efficiency.

It is accordingly a general object of this present invention to define a utility for externally placed, low frequency Randomic Vibration to the thorax of a patient, as a synergistic adjunct to systemically delivered drug therapy, in a cardiological treatment application associated with angina pectoris and acute myocardial infarction.

It is a further object of the present invention to provide an emergency response system which is adaptable to provide externally imparted, localized, low frequency Randomic Vibration to improve drug therapy and localized drug effectiveness to a variety of body regions suffering from an acute, emergent state of low blood perfusion, such as the body regions of the brain, lung, and the periphery. In essence the present invention describes a method for using Randomic Vibration (emitted from a Randomic Vibration device) for remediation of a state of low blood perfusion, comprising the step of applying Randomic Vibration locally upon a targeted external body surface generally overlying a diseased vasculature responsible for the state of low blood perfusion.

It is a further object of the present invention to provide an emergency response system which is simple and easy to use, without a skill requirement beyond what a nurse, paramedic, or even the patient (i.e. by self administration) could typically provide.

It is a further object of the present invention to provide a preferred therapeutic device comprising a randomic vibrator which is of a size and shape to enable hand held engagement and operation, such as to add portability, maneuverability, and ease of placement of the vibrator to a varying, targeted body surfaces, as well as a moduable or controllable means of applying engagement force by the hand or hands of an operator.

It is a further object of the present invention to provide a preferred randomic vibrator of the aforementioned type which enables random changes to at least one vibration characteristic such as; displacement amplitude, force, frequency, duty factor, directivity, wave shape, and vibratory pattern.

It is a further object of the present invention to provide a preferred randomic vibrator of the aforementioned type which enables a selectable maximum displacement amplitude control, such as to accommodate a tolerance level of a patient receiving Randomic Vibration therapy.

It is a further object of the present invention to provide a randomic vibrator the aformentioned type which operates and preferably varies vibration frequency within a specific frequency range of 1-1000 Hz, preferably within the range of 1-200 Hz and most preferably within the range of about 20-120 Hz. It is preferable to at least randomly vary the emission frequency of Randomic Vibration, such as in the (or between) the 1-1000 Hz range, preferably in the 1-200 Hz range (such as to enable safe use of millimeter level palpable displacement amplitude signals which confer substantial penetrative power), and most preferably in the 20-120 Hz range (such as to match the resonance frequency of the epimyocardium of the heart, whereby the coronary arteries are situated).

It is a further object of the present invention to provide a preferred randomic vibrator with a selection of vibration/body surface attachment interfaces, such as to accommodate a preferred method and/or skill level of an operator in order to enhance Randomic Vibration transmission and effectiveness.

It is a further object of the present invention to provide a Randomic Vibration/body surface attachment interface of the above type, comprising at least one contact (or contact node) adapted in size and shape to enable efficient seating within a rib space of a patient in order to optimize Randomic Vibration transmission to the chest wall and vascular structures within the thoracic cavity.

It is a further object of the present invention to provide a Randomic Vibration/body surface attachment interface of the above type, comprising a pair of preferably adjustably spaced contacts (or contact nodes) such as to enable contact to a pair of application sites preferably bridging the sternum (or bridging any other bony structure upon the thoracic cavity such as the spine or ribs) of the patient, in order to improve penetration to the mediasteinal cavity, and preferably match the anatomic configuration of the base of the heart wherein the coronary anatomy is substantially distributed.

It is a further object of the present invention to provide a Randomic Vibration/body surface attachment interface of the above type, comprising a plurality greater than a pair of contacts (or contact nodes), such as to enable contact at a plurality of application sites (or intercostal space levels) preferably bridging the sternum of the patient, in order to maximize penetration to the heart which is variably situated depending on the anatomy of the patient.

It is a further object of the present invention to provide a Randomic Vibration/body surface attachment interface of the above type, which in addition to supplying the means of transmitting low frequency Randomic Vibration from a vibration source to a patient, is additionally enabled to provide ultrasonographic imaging and/or Doppler readouts such that a skilled operator (when available) may optimize penetration and target Randomic Vibration to a culprit vascular region or target area while concurrently imaging or interrogating the target.

It is a further object of the present invention to provide a Randomic Vibration/body surface attachment interface of the above type, which in addition to supplying the means of transmitting low frequency Randomic Vibration from a vibration source to a patient, is additionally enabled to emit a therapeutic low frequency ultrasonic wave form such as to provide a pair of therapeutic oscillating wave forms (i.e. low frequency vibration plus low frequency ultrasound, or more broadly oscillations in about the 1 KHz-500 kHz range) in concert.

It is a further object of the present invention to provide a Randomic Vibration/body surface attachment interface of the above type, which is not only enabled to transmit low frequency Randomic Vibration from the vibration source and concurrently emit a low frequency ultrasonic treatment wave form (or more broadly oscillations in the 1 KHz-500 KHz range), but is additionally enabled to provide ultrasonographic imaging (e.g. real time 2D, 3D and/or Doppler) such that an operator may optimize penetration and target low frequency Randomic Vibration and low frequency ultrasonic emissions (or more broadly emissions in the 1 KHz- to about 500 KHz range) to a culprit vascular region or target area while concurrently imaging or interrogating the target.

It is a further object of the present invention to provide a Randomic Vibration method and apparatus for enabling cardiac phase controlled time Randomic Vibration delivery. Cardiac phase controlled Randomic Vibration is of particular importance in cases of acute myocardial infarction which have deteriorated into cardiogenic shock, wherein Randomic Vibration limited predominantly to the diastolic cardiac phase provides a positive inotropic effect in addition to chaotic mechanical agitation of the epimyocardium of the heart and coronary arteries.

It is a primary object of the present invention to provide a self contained, first line, mobile emergency response system and kit (and method of Randomic Vibration assisted drug delivery) for treatment of acute, emergent, thrombotic and/or vasospastic vascular obstructions by trained professionals (in the ambulance, before transportation, or in hospital), wherein the mobile, emergency response kit comprises: a non-invasive low frequency randomic vibrator, plus any one or combination of, a selection of interchangeable attachment interfaces including those enabling ultrasonic imaging and low frequency ultrasonic therapeutic emissions, a drug delivery means, at least one and preferably a plurality of useful drugs to be delivered, a set of instructions indicating method of use, and a portable carrying case enabling storage and portability of the aforementioned members. Options to the mobile, emergency response kit include: an engagement means (selectable between a clamp and belt apparatus), and a cardiac phase controlled Randomic Vibration delivery system (to optimize the timing of vibration delivery specifically for cardiac applications, which is of special importance in the case where the patient deteriorates into a state of cardiogenic shock). The emergency response kit is especially useful for pre-hospital thrombolysis application for ST elevation myocardial infarction, and can also be used as an adjunct to first line therapy for acute ischemic stroke, typically preferred in an emergency room after a stroke has been determined as non-hemorrhagic.

It is a further object of the present invention, to provide a self contained, portable, emergency response system and kit (and method of Randomic Vibration assisted drug delivery) for outpatient community use, wherein the portable emergency response kit comprises a low frequency randomic vibrator, and preferably at least one of an anti-anginal and/or clot disruptive drug agent to be delivered. The portable emergency response kit is employable to a victim (or bystander) in the community for self- (or assisted) treatment of chest pain (angina pectoris) or acute stroke refractory to and/or complimentary with conventional anti ischemic therapy (e.g. nitro spray, aspirin), wherein an acute coronary or cerebral event cannot be ruled out.

### 5. BRIEF DESCRIPTION OF THE DRAWINGS

The apparatus and method of the present invention will now be described with reference to the accompanying drawing figures, in which:

FIG. 1 is a perspective view of a supine patient receiving treatment from an operator-held randomic vibrator for treatment of acute arterial thrombosis within the thoracic cavity according to an embodiment of the invention.

FIG. 2 is a graphic illustration of an example of a randomic vibratory waveform, according to an embodiment of the invention.

FIG. 3 is a perspective view of a variant randomic vibrator used for treatment of acute ischemic stroke according to an embodiment of the invention.

FIG. 4 is a perspective view of a variation of the randomic vibrator incorporating ultrasonographic imaging with treatment Randomic Vibration via a hand held technique according to an embodiment of the invention.

### 5. DETAILED DESCRIPTION AND PREFERRED EMBODIMENT

According to an embodiment of the present invention, a first line emergency response system and apparatus is provided for pre-hospital or initial in-hospital treatment of patients experiencing an acute to sub-acute thrombotic vascular obstruction and/or associated vessel spasm. The emergency application of noninvasive, transcutaneously imparted low frequency Randomic Vibration (vibration with at least one, and preferably a plurality of randomly varying; pattern, waveform, duty factor or directivity characteristics), optimally as a synergistic adjunct to systemically delivered drug therapy, with or without concomitant ultrasonic imaging, for lysing and vasodilating acute vascular thrombotic obstructions, relieving spasm (if associated), and thereby restoring blood perfusion is disclosed. The present embodiment of the invention is particularly effective against thromboses in the thoracic mediasteinal cavity (i.e. coronary thrombosis and pulmonary embolus) and in treatment of acute ischemic stroke.

Low frequency Randomic Vibration shortens the onset and accelerates the effectiveness of thrombolytics. Due to the urgency to treat heart attacks, strokes, pulmonary emboli, or acute peripheral arterial obstructions to major vessels, as cell death is directly proportional to time, it is of utmost importance to enhance the onset and accelerate the effectiveness of the imparted drug treatment in lysing or clearing vascular obstructions.

The noninvasive application of low frequency Randomic Vibration, in addition to its potential immediate availability to expedite emergency treatment, has the further advantage of not causing undue heating of the overlying tissue superficial to the site of vascular obstructions. Furthermore, the localized biophysical nature of low frequency Randomic Vibration treatment is advantageous in that as it is not a drug, it will not cause adverse systemic biochemical effects, which can otherwise be difficult to reverse such as hemorrhage.

The term “Randomic Vibration” according to the present invention relates broadly to a reciprocating back and forth movement of an attachment interface (or vibratory contact) to be applied to or strike against (or percuss) a body surface of a patient, wherein at least one of the waveform characteristics or patterns of the vibration/percussion are randomly varied, and should not be construed to mean, or be limited to any particular form of vibration unless otherwise specified. Randomic Vibration comprises the random variation of at least one of: vibration wave shape, pattern, displacement amplitude, force, frequency, or duty factor, however other parameters such as directivity of the vibration impulse may also be randomly varied. Furthermore, the term “continuously applied” or “continuous” Randomic Vibration refers to Randomic Vibration applied without a substantial break (or pause) in cadence with respect to the specific definable periods within a cardiac cycle. In other words, for cardiac applications, “continuous” Randomic Vibration refers to Randomic Vibration imparted throughout (or substantially throughout) the cardiac cycle, and not just during one of the diastolic or systolic phase of the cardiac cycle. “Diastolic” timed Randomic Vibration by contrasts refers to Randomic Vibration timed selectively during the diastolic period of a cardiac cycle, which may be helpful should a patient deteriorate into cardiogenic shock.

The preferred embodiment of the emergency response system, or “Randomic Vibration Therapy”, involves the application of “continuously” applied, noninvasive mechanical Randomic Vibration within a frequency range of about 1-1000 Hz (but more preferably within the range of about 1-200 Hz, and most preferably 20-120 Hz—such as to match the resonance frequency of the heart and/or other vital internal organs), to the chest wall as an adjunct to thrombolytic therapy in the treatment of acute ST elevation myocardial infarction (STEMI). A selectable source output displacement amplitude range of 0.1 to 15 mm is provided. Maximum, or peak displacement amplitude for use in any one application is controllable by an operator, such as to limit the intensity of Randomic Vibration exposure to a safety or tolerance level of a patient receiving therapy. The emergency response system is not complicated and can be applied by a minimally trained paramedic or nurse without the need for special skilled imaging guidance or targeting.

The emergency response system facilitates the action (i.e. enhances the diffusability and penetrability) of drugs such as: thrombolytics (e.g. ACTIVASE™ (Alteplase), TNKase™ (Tenecteplase), RETAVASE™ (Reteplase), Abbokinase™ (Urok.inase), Kabikinase™ (Streptokinase with water), Streptase™ (Streptokinase with 0.9% NaCl solution), and Lanoteplase); GP 2b 3a platelet inhibitors (e.g. ReoPro™ (Abcixirnab), AGGRASTAT™ (Tirofiban hydrochloride), and Integrelin™ (Eptifibatide)); calcium channel blockers (e.g. ISOPTIN™ SR (Verapamil HCI), ADALAT™ XL (Nifedipine), Cardizem™ (Diltiazem), and NOR VASC™ (Amilodipine besylate)); Nitrates (e.g. Nitroglycerine (spray, pill or patch), isosorbide dinitrates (Isordil™ and Sorbitrate™), and Nipride™ (Nitroprusside)); Oral anti-platelets (e.g. Acetylsalicylic Acid (Aspirin), Plavix™ (Clopidogrel), and TICLID™ (Ticlopidine hydrochloride)); Anti-coagulants (such as heparin, and other blood thinning and coronary vasodilatory medication); concentrated oxygen and oxygen of ambient air. Microbubbles may also be used as an adjunct to Randomic Vibration therapy, when ultrasound or frequencies above about 1 kHz are used.

For heart attack applications, low frequency Randomic Vibration is preferably imparted to the chest wall (or other transthoracic body surface), and thereby by transmission to the epimyocardium of the heart and coronary arteries. A preferred embodiment, Randomic Vibration adjunctive to thrombolytic therapy, is particularly effective for the treatment of STEMI comprising an acute coronary thrombotic event. Randomic Vibration therapy can, with drug delivery, also be utilized for other forms of acute coronary syndromes such as Non Q wave (i.e. “Non ST elevation) M1 or Unstable Angina where symptoms are otherwise refractory to medical management. A lower maximal displacement amplitude may be considered for Non ST elevation coronary syndromes (e.g. to prevent bruising to the chest wall), wherein the maximum displacement amplitude level (or in a variation, peak force) of Randomic Vibration is gradually titrated upwards until a relief of symptoms (or resolution of electrocardiographic evidence of ischenia) is realized.

Randomic Vibration therapy is effective as a first line medically adjunctive noninvasive mechanical intervention to coronary thrombolysis. During cardiogenic shock, lytic therapy alone, especially without the immediate availability of a cardiac cathlab, has an extremely low rate of success, yet often remains the only realistic chance for reperfusion and in-hospital survival in centers without the option of emergency rescue Percutaneous Coronary Intervention (“PCI”).

Randomic Vibration therapy may also be employed in conjunction with a lower dosage of thrombolytic drugs, independently, or in conjunction with other forms of medications when thrombolytic therapy is either contraindicated (e.g. because of a risk of bleeding), or not prescribed (e.g. non-ST elevation M1 or unstable angina refractory to conventional medical management).

There are three primary effects of Randomic Vibration therapy. First, thromboses or clots are disrupted as the chaotic mechanical pulses create multidimensional sheer stresses due to cavitation and multi-vectored sonic streaming and thereby loosens or breaks apart the clot, with extremely high efficiency, resulting in increased fibrin binding sites, and improved lytic penetration. Second, randomic sonic streaming (chaotic motion of fluid in a Randomic Vibration field) and chaotic convection currents aid the agitation and diffusion process and promote mixing of intravenous drugs from the systemic circulation to the occluded, zero flow culprit vessel. Third, coronary vasodilatation within the culprit circulation is achieved as the smooth muscle within the thrombosed, often spasming coronary artery wall is relaxed by Randomic Vibration (due to a Randomic Vibration induced decoupling of the actin-myosin filaments of the sarcomere). Secondary therapeutic effects include a localized endogenous release of tissue plasminogen activator, an improved left ventricular (“LV”) myocardial relaxation with a lowering of LV diastolic pressures (and thus potential improvements to diastolic, transmural coronary flow), the potential for a positive isotropic effect (leading to an increased lytic filtration pressure which is particularly useful in cardiogenic shock cases), the potential for decreased myocardial oxygen demand for equal contractility, and an improvement of lung/gas oxygen exchange (to provide additional oxygen to the heart and help relieve ischemic burden).

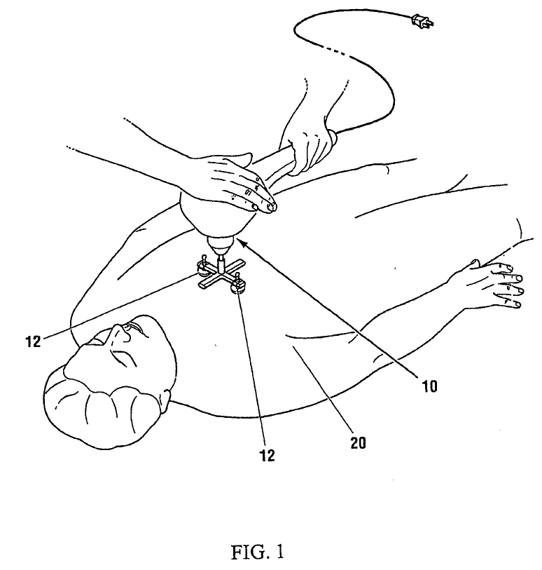

Referring to FIG. 1, a patient 20 undergoing Randomic Vibration therapy according to the preferred embodiment is shown (IVs, drugs, nasal prongs and monitoring equipment etc. not shown). The preferred engagement means, the hands of an operator, for applying low-frequency Randomic Vibration via randomic vibrator 10 to the patient 20 via a pair of contacts 12 spaced to enable seating to the rib spaces to either side of the sternum is shown. Treatment begins with the administration of IV systemic thrombolytic therapy, plus any other helpful drug which is designed to effect clot dissolution and/or vasodilate the culprit coronary vessel.

Thrombolytics may be continuously administered intravenously, and/or by bolus as prescribed by the physician. The contacts 12 of the preferred randomic vibrator 10 are placed at the treatment site upon the chest wall of the patient 20, and Randomic Vibration at high displacement amplitude (preferably with the highest peak displacement amplitude setting tolerable and judged safe to patient 20) is initiated. Randomic Vibration is preferably administered once drug therapy has been established, however may alternatively be initiated before or concurrent with the administration of drug therapy.

In acute myocardial infarction cases treated in an Emergency Room, preparation of the patient 20 should include sedation in similar manner to that of a cardiac cathlab PCI treatment where the patient is expected to remain flat (preferably supine) and relatively still for a period of time despite an anticipated uncomfortable procedure. The recommended application time is half an hour to an hour, or until clinical signs of reperfusion become manifest. An intravenous line is established for introduction of thrombolytic therapy, and any other drug therapy. Sedatives and anti-nausea medication and a foley catheter may be administered to avoid interruptions of treatment. A superficial administration of lidocaine to the skin of the chest wall application site may be considered. Oxygen should be administered to assist breathing. Intubation may be required with congestive heart failure cases in order to maintain oxygen saturation and patient positioning in a near supine position. When treatment commences in the field (as in an ambulance en route to hospital) a less extravagant preparation may be considered, and simply reclining a patient onto a stretcher with the establishment of an intravenous line would suffice in most situations.

For use of randomic vibrator 10 in cardiac applications, the patient 20 is preferably placed supine, although two pillows behind the head may be allowable when the patient 20 is short of breath. Next, the randomic vibrator 10 is turned on, (preferably initially at a low peak displacement amplitude level such as 1 or 2 mm) and the contact or contacts 12 are placed against the target site (or sites) on the patient 20.

In an alternative method a plurality greater than a pair of contacts 12 may be employed, such as to enable seating to a plurality of rib spaces upon the chest wall of patient 20, such as to increase tissue coverage and thereby improving the likelihood of penetration to the heart which can be variably situated within the thoracic cavity. U.S. patent application Ser. No. 10/902,122 to Hoffmann discloses exemplary attachment interfaces suitable to transthoracic applications and, and is incorporated herein to the present invention by reference.

In an alternative method to establish optimal transmission to the heart, Randomic Vibration therapy may be provided in conjunction with high frequency diagnostic ultrasonography (i.e. “HFUS” around 1-50 MHz, preferably 1-5 MHz, most preferably about 1-2.5 MHz) in order to target Randomic Vibration in both heart attack and acute ischemic stroke applications. In this “imaging” embodiment, a “dual function”, simultaneous Randomic Vibration and imaging system may be employed via a single combined imaging/treatment probe. In this variation to the preferred “non-imaging” embodiment, low frequency Randomic Vibration therapy is advantageously employed in conjunction with high frequency ultrasonography (i.e. HFUS), where both high and low frequency wave forms are applied simultaneously (i.e. in real time) via a single hand held instrument, which comprises an ultrasonic imaging transducer operatively connected (or acoustically coupled) to the active end of a low frequency Randomic Vibration source operational in the 1-1000 Hz range. The ultrasound imaging transducer acts in this case as a variant attachment interface (or contact) to the patient 20, thereby enabling the transmission of low frequency Randomic Vibration from the Randomic Vibration source, while concurrently enabling ultrasonic imaging to direct Randomic Vibration. The method of the dual function system comprises the placement of the imaging/treatment probe (with the accompaniment of ultrasonic conduction gel) to the skin of the patient 20, such as to establish a sonic penetration window depicting a target of low frequency Randomic Vibration (such as the base of heart in AMI cases, as described earlier). Once a sonic penetration window is established, low frequency Randomic Vibration is initiated and transmitted through the ultrasound imaging transducer attachment interface (preferably as an adjunct to drug therapy), and the application site is additionally maintained through continued monitoring of the ultrasonic image provided. In this manner, intelligible anatomic placement and angulation of the imaging treatment probe is achieved, thereby optimizing the delivery of low frequency Randomic Vibration therapy to the culprit vascular region targeted.

Optimally in still a further variation, low frequency ultrasonic treatment (LFUS) is also used in combination with HFUS imaging and low frequency treatment Randomic Vibration in the 1-1000 Hz range, via a “multifunction system” employing a single variant LFUS enabled imaging/treatment probe (not shown). In this variation to the preferred embodiment, low frequency Randomic Vibration therapy is employed in conjunction with high-frequency ultrasonography (i.e. HFUS) and “treatment” low frequency ultrasound (i.e. LFUS) simultaneously and in real time, where all three wave forms are applied in concert via a single transmission instrument. In this manner, direct HFUS imaging and targeting may be combined with low frequency Randomic Vibration in the 1-1000 Hz range, and low frequency ultrasonic energy (at around 1 KHz-500 KHz, preferably 20-100 kHz, most preferably about 27 kHz), to optimally agitate and disrupt the culprit vascular region targeted.

The use of a combined imaging/treatment probe, (or “single transmission instrument”), regardless of employment of the “dual function” or “multifunction” system, at least initially involves a skilled imaging technique to direct Randomic Vibration therapy to the ideal sonic penetration window (which would typically be on the chest wall for coronary applications, or employ one of a plurality of known transcranial sonographic windows to the neck or skull in acute ischemic stroke applications). The use of both hands to support and maintain the imaging/treatment probe with enough engagement force to the chest wall is suggested, or the operator can alternatively, use one hand, or utilize any of the suggested engagement means according to the present invention, as long as the appropriate sonic penetration window is visually monitored and maintained. An inertial weight may be placed to the backside (or optionally within housing) of the chosen “transmission instrument” particularly for cardiac applications, adding inertia to the apparatus and thereby assisting the operator ergonomically who may hold the transmission instrument in position by hand.

While the supine position for the patient is generally preferred in cardiac applications, different patient positioning (e.g. with the patient lying to some degree on his or her left side, up to the left lateral debecutis position) could be utilized as per the judgment of the operator, especially when trained in cardiac ultrasonic imaging, in order to establish the highest quality and most stable sonic penetration window available. The parasternal windows remain the preferred application site if available (i.e. in coronary applications), however other sonic windows may be considered.

Duty factor and intensity level may be selected with respect to the LFUS application (i.e. in the multifunction system), such as to provide the means to avoid undue heating to the skin surface of the patient 20. Alternatively, a wet cool cloth applied intermittently to the skin surface, and/or a periodic change of application site (or even transmission instrument), may be utilized to prevent skin burning of the patient 20 during joint LFUS use.

The next step in the preferred treatment method in coronary applications is to apply appropriate engagement force and displacement amplitude to the chest wall of the patient 20 with randomic vibrator 10. The attending clinician applies force to randomic vibrator 10 against the target area by hand, or alternatively via differing engagement selections of a clamp (not shown), or other fixture such as by belt or vest (not shown). A relatively constant, firm engagement force of at least 5-10 N, preferably 20-100 N, and optimally 50-100 N, should be obtained according to the tolerance and safety of the patient 20. The engagement force should preferably not exceed 100 N, such as to avoid possible dampening of oscillations of the randomic vibrator 10 or injury to the patient 20. A force meter (not shown) may be optionally utilized to confirm engagement force. In the preferred case where the randomic vibrator 10 is engaged by the hand or hands of an operator, the engagement force can be monitored, maintained and modulated as per the articulated needs (or tolerance levels) of the patient 20. Referring back to FIG. 1, the housing of the randomic vibrator 10 is advantageously “L” shaped, incorporating a handle to facilitate hand held operation. Activation of the randomic vibrator 10 preferably precedes engagement, however alternatively the randomic vibrator 10 may be activated after engagement to the patient 20, at the discretion of an operator.

As a rule of thumb for coronary applications, the engagement force should include the maximum force, which is tolerable for the patient 20, and will not cause the randomic vibrator 10 to significantly dampen (or stop) its oscillations. Satisfactory engagement is further identified once the patient* identifies a “fluttering” in the teeth or jaw (or exhibits an undulation in the voice) which indicates efficient transmission. It should be noted that patient comfort can be greatly improved by moving the application sites about, even slightly within the rib spaces, or alternatively to differing rib spaces (in keeping to the selection of methods previously described).

Randomic Vibration therapy preferably continues with selection of the maximum peak displacement amplitude or force setting judged safe and tolerable applied for emergency coronary situations. This maximal setting, may result in bruising to the chest wall (or other body surface treated), and an informed consent should preferably be signed by the patient 20 if feasible. It should be understood that the exact order (or selection of steps) in the application of engagement force vs. peak displacement amplitude level of the randomic vibrator 10 against the body surface of the patient 20 is not critical, as long as the end result (i.e. for Randomic Vibration therapy) is that a firm engagement force (i.e. at least 5-10 N, and preferably within the range of 20-100 N) at a high maximal displacement amplitude (i.e. greater than about 1 mm preferably, and preferably in the range of at least 2-15 mm, and ideally maximized to patient 20 tolerance) is ultimately established.

If maximal displacement amplitudes settings of less than or equal to about 2 mm, and/or engagement forces of less than approximately 10 N are not tolerated to the chest wall of the patient 20 (even in the special case where lidocaine is administered to the chest wall surface), then patient 20 may optionally be placed in the prone position (not shown) and the contacts 12 may be placed to bridge the spine of patient 20 in the upper thoracic region. Randomic Vibration at higher displacement amplitudes (often tolerable to about 6-15 mm), and higher engagement forces (often tolerable to 50-100 N or greater), may be safely utilized in the majority of these cases, to ensure and maximize penetration to the mediasteinal cavity and enhance clinical effectiveness of Randomic Vibration. Alternatively, patient 20 may be placed upon a chair or stretcher wherein a suitable Randomic Vibration source is disposed upon or within the upholstery of the chosen furniture item, such as to enable Randomic Vibration delivery to the upper back of patient 20.

Tests by the co-applicant (Hoffimann) disclosed in U.S. Ser. No. 10/902,122 have shown that low frequency vibration penetration through soft tissue is generally related to the applied displacement amplitude and engagement force of the vibration contact to the body surface vibrated. It has been ascertained that the desired engagement force of a Randomic Vibration source placed against the chest wall of the patient 20 is preferably at least 5-10 N, and optimally greater than 20 N, and up to 100 N (when tolerated), to confer ideal penetration. When vibration is applied to the muscle groups adjacent to the spine of the patient 20 (as an alternative means of transthoracic Randomic Vibration to the mediasteinal cavity), engagement force can be much higher (i.e. greater than 50-100 N may be utilized), as the application is far better tolerated by the patient 20, and higher engagement force and displacement amplitudes are generally required to achieve therapeutic levels of mediasteinal cavity penetration.

Optimal displacement amplitudes also vary significantly with the constitution and tolerance levels of the patient 20, as well as the selected body surface treated. Randomic Vibration displacement amplitudes of greater than 1 mm (and preferably in the range of at least about 2 mm-6 mm), are preferred for chest wall applications, and displacement amplitudes of at least about 4 mm-15 mm are preferred for transthoracic applications from the backside of the patient 20. In the case where ultrasonic (HFUS) imaging is employed to direct or target Randomic Vibration therapy, penetration to the heart is generally increased, and higher amplitudes and engagement forces of Randomic Vibration (i.e. which may cause bruising to the skin surface vibrated and patient 20 discomfort) are not absolutely required. Still however (regardless of the use of HFUS enabled directed therapy), the highest possible combination of engagement force and peak displacement amplitude is still recommended to yield best results in emergency treatment of acute coronary, pulmonary, or peripheral thrombotic vascular obstructions. Once placement site, peak amplitude and engagement force of randomic vibrator 10 is established, the operator will select a form of Randomic Vibration therapy, where a vibration displacement amplitude range and vibration frequency range are defined, and at least one of vibration pattern, frequency, wave shape, force, displacement amplitude and/or directivity is randomly varied. Randomly varying vibration wave shapes and frequency (within the preferred frequency range of 20-120 cycles/second) at or near peak tolerable displacement amplitude is the preferred approach for STEMI applications, however other approaches of Randomic Vibration therapy may be used.

In the case that the patient 20 is unable to tolerate even modest levels of Randomic Vibration (i.e. both displacement amplitude and engagement force, regardless of body surface vibrated), then a gentle application utilizing the weight of the randomic vibrator 10 (or at the least 5 newtons of engagement force) and the maximum peak low level of displacement amplitude tolerable to patient 20 should be utilized. Peak displacement amplitudes of 1-2 mm (or even less, e.g. 0.1-1.0 mm may be utilized) in these cases.

The Randomic Vibration frequency range employed is preferably between 1-1000 Hz according to the present invention. It is preferable to match the resonance frequency of the heart, which falls generally within the 1-200 Hz range, and more specifically between the 20-120 Hz range. The heart, receiving Randomic Vibration stimulus at or near its resonance frequency will vibrate with the highest possible displacement amplitudes at the localized areas which best receive the signal. External Randomic Vibration at the resonance frequency enables transmission of the Randomic Vibration signal internally throughout the ventricular chambers with highest efficiency, thereby vibrating the entire heart and effecting optimal intra ventricular transmissibility. Optimal intra ventricular transmissibility aids agitation of the entire coronary tree, including those parts of the tree hidden behind lung or soft tissue which are poor transmitters of Randomic Vibration and therefore otherwise difficult to penetrate directly with sonic mechanical energy. The preferred frequency for chest wall Randomic Vibration centers between about 20-120 Hz compressional waves, owing to this frequencies known superior chest wall penetration, intra-ventricular transmissibility, lytic penetration, clot disruption, and arterial vasodilatation characteristics. It should be pointed out that randomly varying the application frequency in differing individuals is a particularly valuable feature in coronary thrombolysis applications, as the resonance frequency of the heart and myocardium will differ from individual to individual, hence guaranteeing at least a portion of therapy directly at the resonance frequency.

Higher frequencies (i.e. 200-1000 Hz), or even in the sub-ultrasonic to ultrasonic range (i.e. 1000 Hz-500 kHz), while optional for clot disruption and improved drug action to sites of thromboses, are generally higher than the resonance frequency of the heart and hence not readily transmissible to all areas of the coronary anatomy by intra ventricular transverse transmission means. Higher frequency Randomic Vibration also requires diminished displacement amplitude for safe clinical use (i.e. such as at randomic emission frequencies of greater than 200 Hz, and even more so at emission frequencies greater than 1000 Hz), which is a further limitation to this wave-form's potential penetrating and agitative power (i.e. through the chest wall or other body part treated). A directed approach through an identifiable sonic penetration window to ensure adequate penetration to target areas by the much weaker (i.e. lower displacement amplitude—in the low millimeter to sub millimeter ranges) signal is strongly recommended for frequencies greater than 200 Hz, again at the highest amplitudes and forces judged tolerable to a patient in emergency situations.

Concomitant simultaneous high frequency ultrasound imaging (i.e. HFUS) in conjunction with lower displacement amplitude Randomic Vibration therapy at frequencies of greater than 200 Hz, to target and direct a sonic penetration pathway to culprit areas (as per the dual function system described earlier), is the optimal method of employment for such higher Randomic Vibration treatment frequencies.

Generally, a range of frequencies selectively chosen between 1-1000 Hz, with the selection of multiple displacement wave-forms and displacement amplitudes is disclosed. The present invention provides a broad range of frequencies, displacement amplitudes and wave-forms (all of which may or may not be placed in a randomic mode) which are advantageous, as the apparatus and system is optionally employed both as a treatment system and a research tool.

Treatment for acute ischemic stroke, in contrast to treatment of acute coronary thrombosis, is preferably quite gentle, with a maximum displacement amplitude setting (preferably applied to the posterior region of the neck adjacent and pointing towards the base of the skull) generally less than or equal to about 2 mm (i.e. displacement amplitude randomly varying between about 0.1-2 mm). Lower amplitude Randomic Vibration is employed to minimize the chances of cerebral hemorrhage or hemorrhagic transformation following reperfusion. While application of Randomic Vibration to the posterior neck is preferred (because it is very comfortable and relaxing to the individual treated) other attachment regions to the skull itself or differing parts of the neck may also be used (such as over the carotid artery). Treatment durations for acute ischemic stroke are preferably short, such as about 15-20 minutes during intravenous infusion or post bolus of thrombolytic or other clot disruptive drug therapy, however longer or shorter Randomic Vibration treatment sessions may be used as well. Randomic Vibration may also be used as a stand alone therapy (without drugs) or may be applied prior to or after drug administration.

Treatment, for heart attack or stroke continues during and/or post the administration of preferred drug agent(s) wherein stated agents may be selected solely or in any combination from the group of thrombolytics, GP 2b 3a platelet inhibitors, anticoagulants, oral anti-platelets, vasodilators, cavitating micro bubble solutions, concentrated oxygen, and the oxygen of ambient air. Randomic Vibration treatment ends once clinical signs of reperfusion are identified (eg. ECG ST segment resolution, resolution to chest pain in absence of narcotic, reflow noted on transcranial doppler, restoration of function to paralyzed motor region etc.) or until emergency invasive treatment (i.e. PCI, intra-arterial thrombolysis, and/or emergency revascularization surgery) is established.

Regardless of method employed (i.e. for heart attack or for acute ischemic stroke), the patient 20 should preferably be monitored by at least one clinician or nurse (or at least a responsible bystander) during the course of emergency Randomic Vibration therapy. Pain and nausea may require an adjustment in the amplitude or engagement force of Randomic Vibration or even a cessation of treatment. The operator can readily adjust or remove the randomic vibrator 10 (or provided variant) as required. Particularly the operator or clinician may adjust the treatment to suit patient 20 physiological status, such as in a sudden drop in blood pressure, usually indicating deterioration into cardiogenic shock. The operator may decide to discontinue “continuous” Randomic Vibration therapy (i.e. Randomic Vibration applied throughout the cardiac cycle), which may have a negative inotropic effect on heart failure, and switch to “diastolic” timed Randomic Vibration, which is known to provide a positive inotropic effect. If hemodynamic compromise is borderline, the operator may optionally limit or reduce the maximum displacement amplitude setting of Randomic Vibration selectively during the time period of ventricular systole, while maintaining a greater maximized displacement amplitude during ventricular diastole.

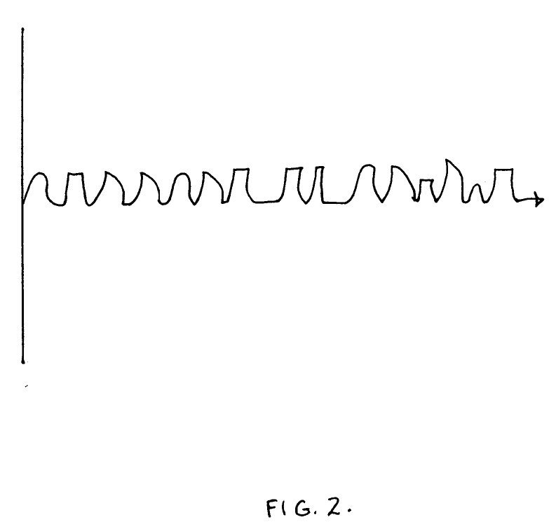

In reference to FIG. 2, low frequency Randomic Vibration via a plurality of displacement wave forms with “displacement” on the vertical axis and “time” on the horizontal axis, (with respect to the movement of a contact 12) is shown, according to an embodiment of the invention. By way of example only, sinusoidal, square, exponential (sawtooth) waveforms are randomly depicted, with varying cadences, and displacement amplitudes.

The above methods of low frequency Randomic Vibration therapy may be used for several pathologies and in different settings. Six prophetic examples of clinical use illustrated in reference to the heart, in various inhospital or pre-hospital settings are as follows:

First, Randomic Vibration therapy may be employed in an emergency room or even more preferably in an ambulance (e.g. pre-hospital thrombolysis) in the first line treatment of acute ST elevation myocardial infarction, preferably adjunctive to thrombolytics, or any other form of medical therapy.

Second, also in an emergency room or ambulance as a first line treatment, Randomic Vibration therapy may be employed to reduce the dosage of thrombolytics and/or anti-platelet agents required for those patients where thrombolytic therapy and/or anti-platelet therapy is relatively contraindicated due to increased bleeding risks (and also to save costs), or even eliminate the use of drug therapy entirely.

Third, Randomic Vibration therapy may be employed in the in-hospital or prehospital setting for treatment of chest pain (i.e. angina pectoris), which may be refractory to medical management in cases of Non-ST elevation MI or cardiac ischemia preferably as an adjunct to drugs such as but not restricted to IV or SL nitroglycerin, GP 2b-3a platelet inhibitors, heparin, enoxaparin, or aspirin. Lytics are not indicated in such cases. Gently applied Randomic Vibration timed to the diastolic phase of the cardiac cycle may be tried in these cases as a first measure to limit the duration of Randomic Vibration therapy and thereby limit potential bruising to the patient 20 who may be anti coagulated. The maximum peak intensity level of the applied Randomic Vibration may be started low and then be gradually (or incrementally) increased to a threshold of patient comfort. If diastolic only Randomic Vibration does not relieve the chest pain (or if not available) continuously applied Randomic Vibration (i.e. throughout the cardiac cycle, in systole and diastole) should be selected, which is more effective for more serious coronary syndromes wherein the mechanisms are either or both of coronary artery spasm and intermittent coronary thrombosis formation.

This gentle method of progression in duration and gradually increasing peak displacement amplitudes in ischemic but substantially non-infarcting syndromes is important as the situation is not acute, and the patient will likely be (as previously stated) anti-coagulated and may bruise easily.

Fourth, Randomic Vibration therapy may be employed prophylactically in the step down telemetry unit or CCU for example, adjunctive to nitrates (and/or blood thinning medications) for more pronounced coronary events (i.e. with ST/T wave changes on the ECG telemetry monitor) which are otherwise refractory to conventional drug management, whereby an acute denovo blood clot and/or acute coronary vessel spasm at the earliest of stages may be in the process of formation. Newly formed (or forming) blood clots are easily disrupted and mobilized prior to the deposition of fibrin by the Randomic Vibration methods disclosed.

Fifth, Randomic Vibration therapy may be applied to the chest wall in the cardiac cathlab setting as an adjunct to drugs such as nitroglycerine, nipride, verapamil, GP 2b 3a platelet inhibitors, and thrombolytics, for acute to sub-acute procedures prior to, during, or after PCI (or heart catheterization), where there may be significant clotting in the artery at the onset of or immediately following the procedure. Randomic Vibration therapy could for example be utilized pre-procedure, as an adjunct to GP 2b 3a platelet inhibitors +/− throntholytics while the patient 20 is en route to the cathlab for emergency PCI. Post procedure, Randomic Vibration therapy may for example be appropriate in “no-reflow” or “slow-flow” situations following or during an intervention, for instance when clots and/or micro emboli dislodge and affix themselves to the distal, arteriolar circulation to cause very poor flow, chest pain and injury. It should be noted that if chest wall Randomic Vibration therapy where to be imparted during a heart catheterization (or PCI procedure), the guide or diagnostic catheter should be withdrawn from the ostia of the selected coronary artery prior to initiation of the Randomic Vibration therapy in order to avoid shear forces and possible dissection to the ostia of the coronary.

Sixth, Randomic Vibration therapy may be employed in the community for acute states of coronary insufficiency resulting in symptoms of angina pectoris and possible acute myocardial infarction, especially for cases where symptoms are not alleviated by nitroglycerine treatment in the patient 20. Every bout of chest pain or “angina” that patient 20 in the community experiences might represent an acute coronary event wherein a plaque has ruptured and a blood clot (and/or vessel spasm) has formed. In these cases, wherein patient 20 is a known cardiac patient, will typically have tried nitro spray×3, each dose spread five minutes apart, without relief of chest pain which may be quite severe. Patient 20 will then proceed to dial “911” for emergency assistance, wherein the diagnosis of an acute coronary obstruction leading to an acute MI cannot be ruled out until professional care arrives. As stated above, hyper acute early clot formation is particularly amenable to dissolution via mechanical agitation. High amplitude Randomic Vibration therapy concentrated to the chest wall in these instances can provide such agitation, and can be therefore (prophetically) an extremely important first line emergency tool, for capturing the window of susceptibility of a newly formed blood clot and eradicate it before it has a chance to grow and harden, and cause damage to the myocardium, or even sudden death to the patient 20. For treatment, the patient 20 should be ideally resting in either the supine position or seated comfortably upright in a chair. Ideally a friend or bystander should provide Randomic Vibration therapy to the patient 20 (preferably with the continued administration of nitrates) until symptoms have dissipated or until professional care arrives. Diastolic timed Randomic Vibration may be considered as a primary measure for community treatment of angina pectoris, or when accompanied with blood pressure monitoring, Randomic Vibration may be first initiated continuously (i.e. applied through systole and diastole) and then switched to diastolic timed Randomic Vibration in the case the blood pressure where to drop to an unsafe level.

Randomic Vibration therapy is effective in emergency situations where any acute vascular obstruction has occurred and cell death or hemodynamic compromise is imminent, particularly when there is a poor prognosis for drug therapy alone and emergency invasive intervention is delayed or not available.

Acute pulmonary emboli and in particular saddle emboli (which involves a critical life and death situation) are also good candidates for external, transthoracic vibration therapy adjunctive to standard drug therapy (e.g. IV thrombolytics, anticoagulants etc.). Chest wall Randomic Vibration to the vascular region of the lung (pulmonary vasculature) and pulmonary artery are readily achieved by the methods disclosed below.

The underperfused body region in this case is the organ and tissues of the lung and, in the case of saddle emboli, the entire body. A frequency of less than 1000 Hz, and preferably selected from the 1-200 Hz range, and most preferably in the 20-120 Hz range with a maximum tolerable peak force or displacement amplitude setting is suitable for such applications.

Ultrasonic imaging means to target the pulmonary artery (i.e. where saddle embolus is presumed the culprit) may be employed to target the Randomic Vibration therapy. Without ultrasonic imaging, the preferred randomic vibrator 10 (with preferably a pair of contacts 12) is preferably placed to bridge the sternum at the level of the third intercostal space of the patient 20 (which approximates the bifurcation point of the left and right pulmonary artery). Alternatively, chest wall attachment may comprise a plurality of contacts 12 either bridging the sternum or applied to the left sternal margin of preferably the third, fourth and filth intercostal space. A frequency of less than 1000 Hz, preferably in the 1-200 Hz range and optimally in the 20-120 Hz range is then applied with a maximum tolerable peak amplitude setting in conjunction with a systemically delivered drug such as a thrombolytic, anti-platelet, anticoagulant or vasodilatory drug. The application of high amplitude low frequency Randomic Vibration commences adjunctively to drug therapy until signs of reperfusion or until invasive corrective measures may be established. Optionally, Randomic Vibration therapy may be utilized independently (i.e. without a drug), or with a decreased dosage of drugs.

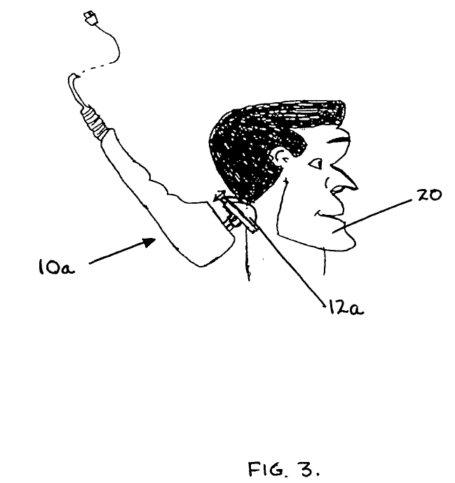

In reference to FIG. 3, Randomic Vibration therapy may also be employed to treat acute cerebral vasculature accidents according to an embodiment of the invention, preferably once determined as ischemic or embolic in origin, adjunctive to thrombolytic therapy where brain function is still arguably salvageable. The underperfused body region in this case is the organ and tissues of the brain of the patient 20. A variant randomic vibrator 10a. (with preferably a pair of contacts 12a), which if functionally equivalent to randomic vibrator 10 accept it may comprise a less powerful motor with a lower displacement amplitude enablement, may be advantageously attached to the posterior aspect of the neck of the patient 20, however the lateral or posterolateral aspects of the neck (or even atop at least one of the carotids) may also be used.

Alternatively, Randomic Vibration may be applied directly to the cranium of the patient 20 (not shown), at a relatively low maximum displacment amplitude to avoid bruising to the head of patient 20. A frequency of less than 1000 Hz, and preferably selected from the 1-200 Hz, and most preferably 20-120 Hz range; is then applied with a peak, maximal selected displacement amplitude (i.e. from 0.1 mm to 15 mm, however preferably less than or equal to about 2 mm displacements, and most preferably less than or equal to about 1 mm displacements), in conjunction with a systemically delivered drug such as a thrombolytic, anti-platelet, anticoagulant, or vaso-dilatory drug. Optionally, Randomic Vibration therapy may be utilized independently (i.e. without a drug), or with a decreased dosage of drugs. A set of head phones with music played may also be used—which is a variant form or Randomic Vibration therapy according to an embodiment of the invention.

Ultrasonic imaging means to target the culprit cerebral vessel may also be employed to target Randomic Vibration therapy. A low frequency Randomic Vibration source set at a frequency of ideally less than 1000 Hz, preferably in the 1-200 Hz range and optimally in the 20-120 Hz range may be coupled to a phased array or other ultrasound imaging transducer sized to enable visualization and more preferably also doppler interrogation of the cerebral arteries via the sonographic windows of the neck or head. Randomic Vibration may be employed together with transcranial Doppler (i.e. TCD) in this emobodiment of the invention, enabling a dual function therapy, where randomic low frequency vibration waveform is coupled to higher frequency imaging ultrasound in the megahertz ranges—which is known to assist thrombolysis in acute ischemic stroke. Randomic Vibration directed by ultrasonic imaging at a relatively low peak displacement amplitude setting is performed in conjunction with a systemically delivered drug such as a thrombolytic, anti-platelet, anticoagulant or vasodilatory drug. The application of low frequency Randomic Vibration commences adjunctively to drug therapy (before, after or most preferably during administration) until signs of reperfusion or until invasive corrective measures may be established. Optionally, Randomic Vibration therapy may be utilized independently (i.e. without a drug), or with a decreased dosage of drugs.

Randomic Vibration therapy in accordance with a further embodiment of the present invention may be utilized to facilitate the restoration of blood flow in peripheral vasculature disease, and more particularly in acute, emergent peripheral arterial obstructions such as those occurring in the limbs of a patient When the obstruction (which is usually thrombo-embolic in nature or involving acute thrombosis on a preexisting ulcerative plaque) involves a critical segment of the arterial system where the collateral potential of blood perfusion is poor, the clinical picture is dramatic with loss of limb viability and amputation imminent if not treated effectively within six hours. Transcutaneous peripheral Randomic Vibration to the vascular region of the effected peripheral body part (including all organs and tissues distal to and including the clavicles and groin region of the patient 20) are readily achieved by the methods disclosed below. A Randomic Vibration frequency of less than 1000 Hz, preferably 1-200 Hz, and optimally in the 20-120 Hz, is applied transcutaneously to the presumed culprit area, preferably at the highest peak amplitude or force levels deemed tolerable and safe to the patient 20). Randomic Vibration therapy is preferably used in conjunction with pharmacologically active agents such as thrombolytics, anti-platelets, vaso-dilatory or anticoagulant drugs as a first line method to restore early flow, and to also act as a bridge to emergency corrective surgery or intervention. A singular or plurality of contacts 12 are utilized to provide maximal agitative Randomic Vibration energy imparted to the culprit area, however alternatively a sleeve (pneumatic or otherwise) sized to envelope an acutely ischemic limb or any other known vibratory attachment interface may be used. The selected vibratory attachment interface is typically placed on the limb surface affected, with contact preferably established at the point at which distal pulses are lost. Typical attachment areas comprise the pelvis/groin area (i.e. iliac and femoral arteries), thigh (femoral artery), popliteal space (popliteal artery), lower leg (tibial artery), periosteum of the clavicle and first rib (sub-clavian artery), soft tissue area between the clavicle and trapezius muscle (sub-clavian artery), axilla (axillary artery), brachium (brachial artery), anti-cubital fossa (brachial artery), and forearm (radial artery). For acute peripheral vascular obstruction applications, the engagement means of randomic vibrator 10 may be by hand, by clamp, or alternatively via a belt engagement system with Velcro™ strap securement or other more traditional securement means (i.e. leather strap with buckle, or tie-able strap). Ultrasonic imaging means to target a culprit blood clot within a culprit vascular region may also be employed (when a skilled imaging technician is present) to enable direct visualization and targeting of the Randomic Vibration therapy with highest efficiency. An ultrasonic imaging transducer or Doppler probe, may be disposed on an active end of the selected Randomic Vibration device to enable real time targeting of the culprit thrombosed vessel through a real time multidimensional image and/or Doppler reading on an ultrasonic display which may be visual or auditory. The application of Randomic Vibration optionally commences with adjunctive drug therapy until signs of reperfusion or until invasive corrective measures may be established. Optionally, Randomic Vibration therapy may be utilized independently (i.e. without a drug), or with a decreased dosage of drugs.

Referring again to FIG. 1, a preferred embodiment of the randomic vibrator 10 (i.e. in the emergency treatment of ST elevation MI) is applied by the hands of an operator with the patient 20 lying substantially in the supine position.

A preferred randomic vibrator 10 of the present invention is operable to generate and emit Randomic Vibration select ably in the 1-200 Hz range. A second variant “research” randomic vibrator (i.e.—“variant 2”—not shown), is also provided, being adapted to operate in a higher frequency range, above 200 Hz, and up to 1000 Hz (which is designed primarily for research applications and applications directed by ultrasonic imaging). Thus, Randomic Vibration therapy within the range of 1-1000 Hz is provided according to an embodiment of the invention.

Randomic vibrator 10 contains an electric motor, preferably a linear stepper motor (not shown) with sufficient power to enable randomized oscillations at engagement forces of at least 20 Newtons and up to approximately 100 N, according to an embodiment of the invention. The motor is disposed within a housing enabling operator hand held grasping and manipulation. Randomic vibrator 10 is characterized to enable selective frequency and displacement amplitude control in the 1-200 Hz and 0.1-15 mm range respectively, as well as selectable displacement “wave form” control (comprising a selection of sinusoidal, square, saw tooth, and exponential wave shapes, or any other programmable variation of linear or nonlinear displacement wave shapes—or combination thereof). Use of randomic vibrator 10 enables the generation and delivery of Randomic Vibration concentrated to the selected body surface treated. The randomic vibrator 10 offers a regular “non-randomic mode” with selectable non-randomic, frequency, displacement amplitude and selectable waveform control, and a “randomic mode” where any number of the above characteristics, will vary randomly according to the preference of the operator.

The active end of the provided linear stepper motor operatively drives the contacts 12 (which are projected from the housing) in a substantially linear, reciprocating pathway. In a variation, a directional control may be added to the linear stepper motor within the housing of randomic vibrator 10, such as to enable subtle randomized anglulation shifts of at least one of the contacts 12 and thereby randomly varying directivity of the emitted vibrator waveform while an operator holds the device static. A preferred embodiment comprises at least a pair of contact nodes which are controllably spaced to enable seating to opposite sides of a bony structure overlying the thoracic cavity of a patient, and most preferably spaced to enable seating to the anatomic left and right of the sternum of a patient receiving therapy. The right and left coronary artery are distributed to the anatomic left and right of the sternum when patient 20 lies supine.

The selection of peak maximal displacement amplitudes ranging from 0 (oft), 0.1, 0.5, 1, 2, 3, 4, 5, 6, 7, 8, 9, 10, 11, 12, 13, 14, to 15 mm deflection is provided by an amplitude regulatory mechanism (although other increments are possible) which is incrementally controlled by the operator. The amplitude regulatory mechanism is enabled by the provided linear stepper motor stroke length control. The stroke length control is coordinated via commands from a processor within and interface upon randomic vibrator 10 (not shown), which all taken together comprise the “amplitude regulatory mechanism” of randomic vibrator 10. Randomic vibrator 10 is also optionally programmable to enable selectable vibration force (or power) control at a given frequency, as an alternate to (or in addition to) the provided selectable displacement amplitude (or stroke length) control.

Operation of preferred randomic vibrator 10 is as follows. The operator inputs commands, which thereafter sends commands to a processor located within randomic vibrator 10, which drives the action of the linear stepper motor. Commands indicate the operator selection of various non-randomic (i.e. when in “non-randomic mode”) or Randomic Vibration signal parameters such as electric motors emission frequency range (e.g. 0 off, 1-200 Hz, 20-120 Hz, or other value), vibratory displacement waveform emission shapes (selectable between sinusoidal, square, exponential, saw tooth and any other programmable waveshape) and maximal peak stroke length and stroke length range of the contact nodes 12 anywhere within the 0.1-15 mm range. A maximum and minimum duty factor of vibration emissions can also be selected.

A fan (not shown) is advantageously disposed within the housing of randomic vibrator 10, (as well as a pair of ventilation holes through the housing—also not shown), to assist convective air cooling of the provided linear stepper motor therein, which enables prolonged application times such that the device will not overheat Alternatively, any other known suitable cooling mechanism may be used. Randomic vibrator 10 is also optionally equipped with a controllable heating system for heating the contact surface of contacts 12, which may add benefit to clot disruption in superficial treatments of thromboses.

Randomic vibrator 10 is preferably powered by an AC power cord, or as a second means via a portable DC battery pack (not shown), which is slide-ably and removably disposed within the handle of the device (not shown) The DC battery pack is advantageous as it enables operation of randomic vibrator 10 in the field wherein no AC power is commonly available.

It should be emphasized that randomic vibrator 10 as herein described comprises a “preferred” means (or apparatus) for the deliverance of emergency Randomic Vibration therapy via direct mechanical contact of contact nodes 12 to a targeted body surface, in the treatment of acute vascular obstructions, and accordingly may be varied in many ways to enable function of an effective emergency response system. In essence, any low frequency non-invasive vibrator (or percussion, or oscillation device by other name) with an attachment interface suitable to enable direct selected body surface contact, operational in the range of 1-1000 Hz (and optimally within the range of 1-200 Hz, and most preferably 20-120 Hz), with a displacement amplitude enablement in the 0.1-15 mm range, preferably in the range of 1 mm-15 mm (for transthoracic cardiac applications such as to ensure adequation penetrative force) which is operable under engagement forces at least 5-10N (and preferably greater than 20 N), may be used to provide an effective emergency tool in the emergency response system.

The variant research randomic vibrator (not shown) of the present invention contains a high powered voice coil adapted to generate Randomic Vibration at higher frequencies within the 1-1000 Hz range. The variant research randomic vibrator is, like randomic vibrator 10, also characterized to enable both selective frequency and force (or power) control at a given frequency, varying wave shape, and is also operational under engagement forces to the human body of up to about 100 N. Frequency settings above 200 Hz have limited displacement amplitude emission capability, in keeping with clinical safety concerns and the mechanical constraints of the provided system, and are thereby confined to the low millimeter to sub millimeter emission ranges (i.e. as low as about 0.1 mm). The provided high powered voice coil (which is located within a housing adapted in size and shape for hand held use) is operatively linked to the proximal non-active end of the vibratory contacts of the variant research randomic vibrator. The vibratory contacts are thereafter projected from the housing enabling contact to patient 20. Vibratory contacts may be equivalent to contacts 12, however any other suitable attachment interfaces may be used. The variant research vibrator is also powered in like fashion to the preferred randomic vibrator 10 (as described above); such as through AC power cord and removable DC battery pack, for example. The variant research vibrator is of preferred for use in conjunction with simultaneous ultrasonic imaging (as per the dual function system—described earlier), as the low displacement amplitude signal at higher frequencies requires direction and the establishment of a sonic penetration window, to ensure therapeutic penetration to target vascular areas within the patient 20. Like in the preferred randomic vibrator 10, the variant research randomic vibrator has a regular “non-randomic mode”, and a “randomic mode”, where any one, some, or all wave shape characteristics are selectable for random emissions.

It should be understood that the choice of a voice coil is not critical to enable Randomic Vibration therapy in the 1-1000 Hz range, and other vibratory means such as a high powered peristaltic linear motor may alternatively be employed. An exemplary peristaltic linear motor may be comprised of a magnetostrictive material optimally incorporating Terfenol D. Alternatively, a linear stepper motor assembly could be used independently, or in conjunction with the magnetostrictive material.

The preferred randomic vibrator 10 (and provided variants) is powered by battery or power cord at a range of voltages (e.g. North America—110, 120 V, Europe—220V, Japan 95, 105 V, Australia 240 V) and is (as stated) operable both by battery and power cord for emergency settings.

Detachable contacts 12 are provided in a plurality of sizes, (i.e. small, medium and large), and made substantially of silicone rubber, however any resilient yet non-obtrusive material (preferably shaped with a convex contact surface in rib space transthoracic applications), to allow comfortable application against the body of patient 20 may be used. The contacts 12 are sized to make contact with an intercostal space of the human body, and rest evenly against the upper and lower rib, with an outward dome shaped convexity to ensure soft tissue contact and concentrate Randomic Vibration therapy effectively. The preferred contact 12 advantageously comprises a semi spherical dome shape, with a flat planar circular base (the base being of similar size to the head of a stethoscope), wherein the base ranges in size between 2 cm, 3 cm and 4 cm diameter. It should be understood that the exact shape of contacts 12 (i.e. a semi spherical dome) is not critical, and that any shaped contact head may be used, as long as efficient seating within the intercostal spaces of the patient 20 is enabled. Optionally, a variety of contacts comprising suction cups (not shown) are provided to enable an additional active retraction force, provided the patient is not significantly diaphoretic. A soft rubber lining (or more specifically, a vinyl lining with foam rubber underlay of known type) may optionally overly the engagement surface of contacts 12 in order to impart a more comfortable application (which is especially useful for extremely tender skinned females with fleshy breast tissue who often are very sensitive to pressure applications to the chest wall). It should also be understood that the exact size of contacts 12 is not critical, and a selection of variant contacts (not shown) with even smaller contact surfaces may be used, enabling a direct seating within the rib space of the patient 20 such that the ribs themselves axe minimally or not touched. This manner of chest wall contact provides a more comfortable application for some individuals.

A preferred embodiment for Randomic Vibration therapy in cardiac applications comprises a pair of adjustably spaced contacts 12 operatively attached to the active end of the linear stepper motor disposed within randomic vibrator 10, to provide concentrated therapy (preferably) to either side of sternum at the selected intercostal space as per the prescribed methodology. In a further variation, to optimize sonic penetrability to the heart and to account for variable location of the heart within the thoracic cavity, a plurality beyond a pair of contacts 12 be used. Placement of a plurality beyond a pair of contacts 12 could be, for example be placed just lateral to the anatomic right and left sternal border, encompassing any two or all of the 3rd, 4th and 5th intercostal spaces. Alternatively, a single contact 12 may be used.

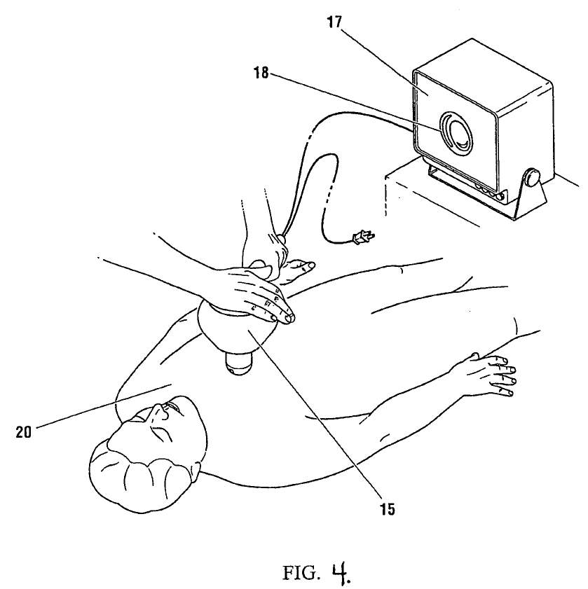

Referring now to FIG. 4, a perspective view of a variation of the preferred embodiment, a hand held single imaging/treatment probe (herein set forth as the “variant imaging Randomic Vibration device 15”), and method as applied to the patient 20 according to another embodiment of the invention is shown. This system (as per the “dual function system” described earlier) employs a low frequency Randomic Vibration and high frequency ultrasonographic imaging (HFUS) taken together in concert (simultaneously) via a single combined hand held transmission unit, for visually directing low frequency Randomic Vibration therapy within the body of the patient 20. The attachment interface of variant imaging Randomic Vibration device 15 contains an ultrasonic imaging transducer (not shown—located at the active end of variant imaging Randomic Vibration device 15, proximate patient 20), whereby a real time multidimensional image can be viewed on ultrasonographic 2-D display 17. The ultrasonic imaging transducer is operatively connected (or acoustically coupled) to a low frequency Randomic Vibration source (also not shown—located within the housing of variant imaging Randomic Vibration device 15) such that upon activation, when the low frequency Randomic Vibration source generates Randomic Vibration, the ultrasonic imaging transducer vibrates and thereby is enabled to deliver low frequency Randomic Vibration simultaneously (i.e. together in real time) with HFUS imaging, all via a shared contact surface to the patient 20. An optional weight added within or exterior to the housing of variant imaging Randomic Vibration device 15 (weight not shown), adds inertia to the system to ergonomically assist the operator (i.e. to apply engagement force) during hand held placement of variant imaging Randomic Vibration device 15 which is particularly helpful in cardiac or other transthoracic applications. An example of a useful ultrasonic image 18 (in this case an image of the heart is depicted), is shown on ultrasonographic 2-D display 17,

The Randomic Vibration source of the variant imaging Randomic Vibration device 15 advantageously comprises the same active components of preferred randomic vibrator 10 (described earlier), and thereby enables selectable displacement amplitude, frequency and displacement wave form control within a 1-200 Hz range with both randomic and non-randomic modes. It should be understood however that this particular selection of Randomic Vibration source is not critical to enable use of the dual function system, and any known Randomic Vibration source operable to generate Randomic Vibration within the 1-1000 Hz range (so long as the therapeutic Randomic Vibration wave form does not disable the necessary ultrasonic imaging wave form) may be used, regardless of the level of provided vibratory emission control. Such Randomic Vibration sources may for example comprise but not be limited to; linear stepper motors, linear stepper motors with displacement amplification, rotary stepper motors with a rotary to linear conversion element such as a cam or crank, magnetostrictive actuators, voice coils, shakers (e.g. with or without neodymium magnet transducers), and ceramic servo motors coupled to either a rotary (with cam) or linear stage. The preferred Randomic Vibration source should be operable at broad range of displacement amplitude settings while under load, such as to optimally enable a high energy penetrative system of Randomic Vibration therapy (or oscillatory or percussive therapy by other name) for transthoracic and most particularly coronary applications.

The ultrasonic imaging transducer of the variant imaging Randomic Vibration device 15 is operatively attached to the oscillating motor (preferably a linear stepper motor) disposed within variant dual function imaging Randomic Vibration device 15, such that when the active end of the oscillating motor oscillates, the oscillations are linearly transmitted to the ultrasonic imaging transducer. The ultrasonic imaging transducer is removably attachable, and other attachment interfaces, such as a singular, pair or greater than a pair of contacts 12 (or any other suitable non imaging contact) may be used. The preferred ultrasonic imaging transducer for use with the variant imaging Randomic Vibration device 15 comprises a phased array imaging transducer enabling real time 2D imaging acquisition, and optionally enabling real time 3D volume acquisition.

should be understood that while a phased array imaging transducer is preferred, any ultrasonic imaging transducer enabling real time multidimensional imaging (2D or 3D), or even blind or imaging guided Doppler interrogation only, may be used for the variant imaging Randomic Vibration device 15 according to the invention. The ultrasonic imaging transducer may be disposed within a protective engagement housing (to reduce wear and tear on the engagement face of the transducer), and is preferably sized to enable operative seating within a rib space of patient 20 to best enable transthoracic cardiac applications.

In a further variation, a variety of attachment interfaces with a plurality of vibratory contacts spread to enable contact to a plurality or ribspaces (as described earlier), some containing an ultrasonic imaging transducer and some not, may be used.

A dual function imaging, Randomic Vibration system with Randomic Vibration source operatively attached to an ultrasonic imaging transducer is also contemplated for treatment of acute ischemic stroke according to an embodiment of the invention. In this embodiment (not shown), a hand held Randomic Vibration source is operatively linked to a ultrasonic imaging transducer (preferably a phased array) enabling visualization of the brain via the sonographic windows of the neck and head. Treatment of acute ischemic stroke is preferably accomplished by Randomic Vibration in the 1-1000 Hz range and 0.1-15 mm range, applied in tandem and directed by transcranial Doppler and/or real time 2D or 3D imaging.

A “multifunction system” is also provided, which in addition to providing a means of transmission for low frequency Randomic Vibration therapy concurrently and simultaneously with ultrasonic imaging via a single transmission instrument (i.e. as above in the “dual function” system), further enables a LFUS treatment wave form emission.

In this multifunction system embodiment (which may be used in both heart attack and acute ischemic stroke applications), noninvasive low frequency Randomic Vibration (i.e. in the sonic to infrasonic range), low frequency treatment ultrasound, and high frequency ultrasonic imaging are utilized nondestructively in concert (i.e. simultaneously) to provide an optimized therapy system for acute vascular obstructions and treatment of ischemic events, optimally employed as an adjunct to systemically delivered drug therapy, to improve localized drug effectiveness.

The multifunction system is generally enabled by a randomic vibratory attachment interface which shares an imaging and lower frequency therapeutic ultrasonic emission surface. For example, an ultrasonic imaging transducer, preferably a phased array, may be disposed around or alternatively placed side by side to an incorporated LFUS actuator (or more broadly, an actuator operable to emit oscillations in about the 1 KHz—about 500 KHz range), such that the active ends (or engagement faces) of both units are directly adjacent to one another and thereby sharing a common application surface for contact to the patient 20. Treatment applicators of similar design to this are discussed in U.S. Pat. No. 5,558,092 to Unger et al, as well as U.S. patent application Ser. No. 11/036,386 to Hoffmann, incorporated herein by reference. The relative geometry (i.e. ultrasonic imaging transducer disposed about the LFUS transducer (or vice versa) and the relative contact surface areas of the two complimentary engagement faces are not critical, as long as both the active contact surface of the LFUS transducer and the active contact surface of the ultrasonic imaging transducer are represented to a sufficient degree to enable their respective functions, and are placed in close proximity to one another, Preferably the shared contact surface provided would be of a size, and shape, to enable efficient seating in a rib space of the patient 20, to optimize use in transthoracic applications. In a variation, a HFUS ultrasonic imaging transducer may be mounted end to end with a LFUS actuator, whereby the LFUS waveform is transmitted directly through the HFUS ultlrasonic imaging transducer.

It should be understood that while the low frequency Randomic Vibration source to the multifunction system also advantageously comprises the active components of preferred randomic vibrator 10 (i.e. to enable a high degree of low frequency Randomic Vibration control), this selection of low frequency Randomic Vibration source is not critical to enable use of the multi function system according to the invention, and any known Randomic Vibration source operable to generate Randomic Vibration within the 1-1000 Hz range (so long as the therapeutic Randomic Vibration wave form does not disable or significantly interfere with the necessary ultrasonic imaging wave form, or therapeutic low frequency ultrasonic wave form, or more broadly waveform in the 1 KHz-500 kHz range) may be used, regardless of the level of provided vibratory emission control. Such Randomic Vibration sources may for example comprise, but not be limited to: linear stepper motors, linear stepper motors with displacement amplification, ceramic servo motors coupled to either a rotary (with cam) or linear stage, rotary motors with rotary to linear conversion elements, magnetostrictive linear motors, voice coils, and shakers (e.g. with or without neodymium magnet transducers), and asymmetrical eccentrically spinning or agitated weights.

In a preferred embodiment, (which utilizes low frequency Randomic Vibration solely in the sonic to infrasonic ranges), randomic vibrator 10 is secured to patient 20 by the hand or hands of an operator, wherein an alternative means of engagement employs use of clamp or a belt (neither shown).

Mobile, Emergency Response System for Paramedic Use: For first line response by paramedics in an ambulance or before transportation, a self contained, mobile, emergency, response kit for the treatment of acute, thrombotic and/or vasospastic vascular obstructions, including a selection of drugs, drug delivery supplies, and the preferred randomic vibrator 10 (with a selection of removable and interchangeable attachment interfaces, including those enabling ultrasonic imaging or lower frequency therapeutic sonic to ultrasound treatment in the 1 KHz to 500 KHz range to enhance Randomic Vibration transmission and effectiveness) is provided. The mobile, emergency response kit may also be employed by nurses and/or physicians in the Emergency room, upon arrival of the patient 20 to hospital. The preferred application is for acute coronary vascular obstructions, yielding a diagnosis of Acute ST elevation Myocardial Infarction. Another preferred application is in the Emergency room for treatment of acute ischemic stroke, preferably once the stroke has been determined as non-hemorrhagic.

The variant research randomic vibrator is of optional inclusion to the mobile emergency response kit, and offers a higher range of Randomic Vibration frequencies within the range of 1-1000 Hz. The variant research vibrator has a limited displacement amplitude enablement (i.e. in the low millimeter to sub millimeter ranges) and is primarily used for research purposes (i.e. in the 200-1000 Hz range) and/or use with ultrasonographic imaging to target Randomic Vibration therapy. The multifunction system as described earlier, enabling imaging and lower frequency therapeutic energy emissions in the 1 kHz-500 KHz range in combination with Randomic Vibration in the 1-1000 Hz range may also be provided.

The mobile, emergency response system comprises a self contained system, employing a module and portable storage carrying case (not shown) which houses the components of the mobile emergency response kit. A variant larger portable storage carrying case (not shown) is adapted to additionally house optional components.

The mobile, emergency response system enables systemic drug delivery, via intravenous, intra arterial, subcutaneous, oral, topical and nasal drug administration means. Drugs within the mobile, emergency response kit include: thrombolytics; GP 2b 3a platelet inhibitors; calcium channel blockers; Nitrates Oral anti-platelets; Anticoagulants; and concentrated oxygen. It should be understood that the mobile emergency response kit may contain any one of the above listed drugs, or any number of the above listed drugs in any combination.

Non-pharmacological “drugs” such as echo contrast agents (i.e. micro bubble solutions which lower the cavitational threshold of a medium), which may be delivered systemically along with other drugs, are optionally included in the mobile, emergency response kit to enhance the agitative internal effects of externally delivered Randomic Vibration therapy, particularly when employed in conjunction with transcranial Doppler, or oscillations within a frequency range of about 1 KHz to about the MHz ranges.

Drug delivery supplies within the mobile, emergency response kit include: IV tubing, IV start kits, sterile IV introduction needles, tape, IV pole, 0.9 NaCl IV solutions, Dextrose IV solutions, Code 8 IV solutions, Heparinized IV solutions, IV pressure bag with pressure gauge and pressure bulb, sterile intra arterial introduction needles, guide wires, sheaths with dilators, scalpel blades, one way stopcocks, three way stop cocks, sterile drapes, sterile gowns, sterile gloves, sterile skin preparation solution, needles adapted to subcutaneous drug delivery, alcohol swabs, paper cups, straws, sublingual sprays, aerosol sprays, oxygen tank, ambubag, oxygen tubing, oxygen mask, and nasal prongs. It should be understood that the mobile emergency response kit may include any one of the above listed drug delivery supplies, or any number of the above listed drug delivery supplies in any combination.

The cardiac phase controlled Randomic Vibration delivery system is optionally included within the mobile, emergency response kit for treatment of Acute Myocardial Infarction particularly when complicated by heart failure or cardiogenic shock. A cardiac phase “mode” selection enables cardiac phase dependent Randomic Vibration delivery, wherein “mode” defines the timing of emission of Randomic Vibration therapy according to cardiac phase (i.e. systole vs. diastole). The selection of Randomic Vibration mode enables the application of Randomic Vibration specifically during the diastolic phase of the cardiac cycle, which is useful in AMI cases which have deteriorated to cardiogenic shock as diastolic Randomic Vibration, besides agitating and assisting dissolution of the culprit coronary obstruction, provides a positive inotropic effect to heart function. The provided cardiac phase dependent Randomic Vibration delivery system is optionally programmable to enable the selection of varying frequency of Randomic Vibration according to cardiac phase. It is advantageous to for example vibrate the myocardium between 1-200 Hz (aid optimally 20-120 Hz) during ventricular diastole (approximating the diastolic resonance frequency of the myocardium).

In implementation of Randomic Vibration timed to the diastole of a cardiac cycle, randomic vibrator 10 (or variant) further comprises a processor and ECG sensor (preferably a three lead system) utilized to determine the start of ventricular systole (by sensing of a QRS complex), where after a pre-programmed and optionally rate modulated delay (approximating the length of ventricular systole) is implemented, where after Randomic Vibration is initiated and maintained until the onset of the next sensed QRS complex. Further, the operator, upon viewing an ECG display monitor with interpolated vibration emission display (not shown), can adjust (or fine tune) the timing of Randomic Vibration emission. In essence the cardiac phase controlled Randomic Vibration delivery system preferably comprises a blended technology of a Randomic Vibration source and known intra-aortic balloon pump diastolic timing technology.

Ideally diastolic timed Randomic Vibration should commence from the terminal end of the T wave, and then discontinue upon the onset of the deflection of the QRS complex as visualized by the provided ECG trace waveform. As stated the use of the diastolic timed Randomic Vibration is of significant importance when the patient 20 is suffering from an acute coronary vascular obstruction which has deteriorated to a state of cardiogenic shock.

It should be understood that while the mobile, emergency response kit advantageously employs the preferred randomic vibrator 10 (such as to enable a high degree of operator enabled Randomic Vibration emission control), this employment (or choice of randomic vibrator 10) is not critical in the mobile, emergency response system and alternatively any low frequency (i.e. operational in the 1-1000, preferably 1-200 Hz range, most preferably 20-120 Hz range) randomic vibrator offering at least one randomized vibratory wave characteristic, with a suitable attachment interface for selected body surface contact (preferably enabling concentrated delivery of Randomic Vibration between the rib space or spaces of the patient 20), being operable in the 0.1—about 15 mm displacement amplitude range, and employable under engagement forces of >5-10 Newtons, and preferably>20 Newtons, and optionally with diastolic timed emission control, may alternatively be used, regardless of the level of operator enabled Randomic Vibration control.

The preferred method of employment of the randomic vibrator 10 (or percussion or oscillation device by other name) for treatment of acute vascular obstructions comprises the following steps: Step (1A) comprises the step of systemically administering at least one and preferably a plurality of useful drugs adapted for treatment of an acute vascular obstruction which is usually a combination of thromboses and vessel spasm. Such drugs may include but not be limited to thrombolytics, GP 2b 3a platelet inhibitors, nitrates, anti coagulants, oral anti-platelets, concentrated oxygen and morphine. Step (1B) comprises the step of applying Randomic Vibration to a selected or pre-determined external body surface deemed generally proximate the acute vascular obstruction via the preferred randomic vibrator 10 (or other suitable percussion device as described above). Application of Randomic Vibration by randomic vibrator 10 is preferred in the case where the operator has no specialized skill or training in ultrasonic imaging (which would be the most common scenario in the field or in the ER).

In reference again to FIG. 1, engagement to the anterior chest wall bridging the sternum is shown (which is preferred in acute myocardial infarction cases, although the backside of the patient and other areas upon the chest wall may also be utilized), and ideally the highest peak force or displacement amplitude deemed safe and tolerable to the patient 20 is selected to ensure optimal penetration and effectiveness of the percussive signal. Step (1C) comprises the provisional step of employing diastolic timed Randomic Vibration via the cardiac phase controlled Randomic Vibration delivery system (or any suitable variation thereof) in the special case wherein the patient 20 deteriorates into a state of cardiogenic shock or cardiac failure, which is not uncommon in acute myocardial infarction cases. Diastolic timed Randomic Vibration reduces LV diastolic pressures, promotes LV diastolic filling, and promotes a positive inotropic effect to LV function by Starling's Law.

Otherwise “continuous” Randomic Vibration may be continued or discontinued in accordance to a risk/benefit decision by a responsible operator. It should be understood that the initiation of Randomic Vibration (1B) may proceed or be concurrent with the administration of drug therapy (1A). Furthermore, it should also be understood that Randomic Vibration therapy (1B) may alternatively be utilized alone without adjunctive drug therapy (1A), such as in the special cases whereby drug therapy is not indicated (i.e. for patients with substantial bleeding risks or other co-morbid factors), drug therapy is not available (i.e. at home or in the field), wherein drug therapy is not allowed or not authorized (e.g. patient refusal, or in the case where the operator is not authorized to give drugs), and/or wherein drug therapy is not preferred or not prescribed.

In a variation to the preferred Randomic Vibration method, the employment of ultrasonic imaging to direct Randomic Vibration may be used. Step (2A) comprises the same step of systemically administrating a clot dissolving and/or vasodilatory drug to the patient 20 as per the prescribed therapy. Step (2B) comprises the step of applying and directing Randomic Vibration by means of ultrasonic imaging (i.e. the variant imaging Randomic Vibration device 15 applied to patient 20 is shown, however any suitable variant randomic vibrator—as described above—coupled to an ultrasonic imaging transducer at its active end may be used). The variant imaging Randomic Vibration device 15 (or variation thereof) is optimally placed and directed via ultrasonic imaging, to emit Randomic Vibration towards an acute vascular obstruction targeted. This is accomplished by either direct visualization (e.g. such as visualization of a blood clot within a blood vessel) or by anatomic reference, wherein for example placement in proximity to the base of the heart, and visualization of the substantially akinetic, basal aspect of the myocardium wherein the culprit blood clot is likely to reside defines preferred placement and direction of Randomic Vibration in acute myocardial infarction cases. Step (2C) comprises the optional step of employing diastolic timed Randomic Vibration via the cardiac phase controlled Randomic Vibration delivery system (or suitable variation thereof) in the special case wherein the patient 20 deteriorates into a state of cardiogenic shock or cardiac failure. Again it should be understood that Randomic Vibration therapy directed by ultrasonic imaging (2B) may be independent of drug therapy (2A), and may alternatively proceed or be initiated concurrently with the initiation of drug therapy (2A).

In reference to the application of the mobile emergency response kit in the field for acute coronary thrombosis cases (i.e. “pre-hospital thrombolysis), a tutored or trained paramedic or physician, once arriving to the patient 20 and establishing a diagnosis (such as an acute ST elevation myocardial infarction), preferably selects at least one drug based upon clinical need and/or patient bleeding risks, systemically administers the drug (or drugs), and then transcutaneously administers Randomic Vibration to the torso (usually the chest wall) of the patient 20 deemed to overly the general area of the acute culprit vascular obstruction. As stated a skilled imaging approach to direct Randomic Vibration may be employed if the operator has the skill and training required to recognize pertinent ultrasonic images, otherwise the preferred randomic vibrator 10 (or other suitable non-imaging vibrator) with a pair or optionally a plurality beyond a pair of contacts 12 adapted for rib space engagement should be utilized. Low frequency Randomic Vibration in the sonic to infrasonic ranges (i.e. 1-1000 Hz; preferably 1-200 Hz or most preferably 20-120 Hz in cardiac applications), may be used. Generally in transthoracic applications, a maximum tolerable (and judged safe) peak force or displacement amplitude should be utilized in cases of acute myocardial infarction or acute vascular obstructions to the pulmonary or peripheral vasculature, wherein cell death, and/or hemodynamic compromise is otherwise imminent. In contrast, for treatment of acute ischemic stroke, a gentle 0.1-2 mm peak displacement amplitude setting may be preferable (preferably via application of the contacts 12 of randomic vibrator 10 or variant randomic vibrator 10a (or other suitable variant) to the posterior, posterior lateral or lateral aspect of the neck of the patient 20—see FIG. 3, (or any other variant transcranial or neck attachment means), preferably once an acute ischemic or embolic stroke has been confirmed. It should be understood however that higher treatment peak amplitudes may be considered as first line treatment according to a risk/benefit weighted decision (i.e. risk of cerebral hemorrhage vs. benefit of accelerated reperfusion) made by the attending clinician. Randomic Vibration may also be applied to at least one of the head or neck prior to determining whether the stroke is ischemic or hemorrhagic.

The patient 20 is transported to hospital or other treatment facility, preferably with Randomic Vibration and drugs simultaneously delivered. The Randomic Vibration therapy preferably continues until clinical signs of reperfusion are evident, or until an invasive corrective procedure such as emergency PCI (i.e. in heart attack cases), or invasive catheter based intra-arterial thrombolysis (i.e. in acute ischemic stroke cases) is established.

Portable, Emergency Response System for Outpatient Use: For first line treatment of a citizen in the community (e.g. before the arrival of paramedics), a self-contained, portable, emergency response kit for the treatment of an acute thrombotic coronary vascular obstruction at early stage is provided. Components of the portable emergency response kit include the randomic vibrator 10, and preferably at least one anti anginal medication to be delivered. The portable, emergency response kit is designed to be utilized by the patient 20 as an emergency tool for self administration (or assisted administration by a non-trained or indeterminately trained bystander) within the community.

The portable, emergency response kit comprises a black leather portable carrying case which is adapted to house and port: the randomic vibrator 10, a portable DC power pack, an AC power cord, preferably at least one anti-anginal medication (such as Nitro spray, Nitro pill, Nitro patch, Isordil™, and/or Sorbitate™), and optimally at least one oral antiplatelet medication (such as Acetylsalicylic Acid, Plavix™, and/or TICLID). A larger brown leather carrying case is adapted to additionally house and port a small oxygen canister and nasal prongs to enable the administration of concentrated oxygen to the patient 20, as well as a small portable blood pressure device adapted to take blood pressure from the wrist of patient 20. A belt engagement system (not shown) may be provided so the patient 20 need not hold the unit by hand during the course of therapy. The patient 20 is instructed to carry a cellular phone at all times to enable calling for emergency assistance when necessary. The use of the randomic vibrator 10 is preferable in the portable emergency response system as the unit is relatively light weight and easy to “self” apply by the patient 20.

Randomic Vibration therapy is, in this case, employed for acute states of coronary insufficiency with symptoms consistent with infarction refractory to nitroglycerine treatment in the patient 20, wherein an acute coronary thrombotic obstruction (i.e. “Heart Attack”) cannot be ruled out. Every bout of chest discomfort that the patient 20 in the community experiences might in fact be an acute coronary event wherein a plaque has ruptured and an acute thrombotic vascular obstruction has occurred.

The method of use of the portable emergency response system and kit comprises maintaining the portable emergency response kit in proximity of the patient 20 at all times. When a symptom of “angina” is felt by the patient 20 (i.e. chest pain or pressure, shortness of breath, nausea, diaphoresis, or “an impending sensation of doom”), patient should undertake anti-anginal medical therapy as prescribed by his or her physician.

In these cases, the patient 20 will try the prescribed anti-anginal medication such as nitro spray×3 (i.e. with each dose spread 5 minutes apart), and upon recognition of no relief of chest discomfort (which may be quite severe), patient 20 will proceed to dial “911” wherein the diagnosis of an acute coronary thrombotic obstruction leading to an acute myocardial infarction cannot be ruled out until a professional diagnosis is obtained. As described earlier, hyper acute early clot formation at early stage is extremely amenable to dissolution via mechanical agitation, hence a mechanically disruptive, agitative technique such as the application of high amplitude chest wall Randomic Vibration therapy as herein described, is prospectively an extremely effective and important first line emergency method and tool.

The patient 20 will rest and preferably additionally administer an oral antiplatelet medication (as above) as prescribed by a family physician or Cardiologist of the patient 20. The patient 20 should articulate the potential medical problem of a potential “heart attack” to bystanders such that patient 20 is not alone while waiting for the arrival of an ambulance and professional care (i.e. in the case of cardiac arrest). Randomic vibrator 10, or other suitable variant randomic vibrator is placed to the anterior chest wall preferably to bridge the sternum at the default level of the fourth intercostal space (although other attachment configurations to other and/or more rib spaces are possible as per the methods described earlier). The blood pressure of the patient 20 maybe monitored via the small portable blood pressure device, and oxygen may be administered until professional assistance arrives.

The Randomic Vibration peak displacement amplitude setting is preferably selected as the maximum tolerable to the patient 20, who should ideally be resting in either the supine position or seated comfortably in a chair. Ideally a friend or bystander should engage the randomic vibrator 10 or other provided randomic vibrator against the patient 20 by hand until professional care arrives. The patient 20 will preferably administer a dose of anti angina! medication such as nitro spray 0.4 rug SL (and optionally an oral anti platelet agent), and then proceed to administer adjunctive Randomic Vibration therapy (as per the methods disclosed earlier) such as to provide a synergistic treatment system to assist localized drug effectiveness to the coronary vasculature. Monitoring of the blood pressure of the patient 20 (i.e. via the optimal small portable blood pressure device) is advantageous as repeated dosing of nitroglycerine (or other nitrate employed) may be accomplished barring hypotension during Randomic Vibration therapy.

As an option, randomic vibrator 10, or other selected randomic vibrator, may be adapted to enable cardiac phase controlled Randomic Vibration via the incorporation of an ECG monitoring system and suitable processing and control network (i.e. as a “self contained unit”—as described earlier), such as to enable the application of Randomic Vibration restricted to the diastolic phase of the cardiac cycle of the patient 20 wherein it may be considered useful to provide a therapy which promotes a positive inotropic effect whereby the blood pressure and hemodynamic status of patient 20 may deteriorate (or will be unknown) until professional care arrives. The ECG monitoring system in this case may in a variant embodiment to a standard three lead, advantageously comprise at least a pair of electrodes operatively incorporated with or disposed upon at least a pair of contact surfaces of the utilized Randomic Vibration attachment interface (e.g. which may for example comprise the preferred pair of contacts 12 as per FIG. 1), such as to enable a simple and easy application means to the patient 20, without the bother of attaching electrocardiographic leads and so forth.

The portable, emergency response system for outpatient use may also be used for treatment of acute stroke whereby the randomic vibrator 10 or suitable variant randomic vibrator is placed to at least one of the neck or head of an individual in need of therapy. Treatment of acute ischemic stroke via Randomic Vibration is preferred (vs hemmoraghic) as the goal is disruption and clearance of acute cerebral arterial thrombosis. It is significant that acute thrombotic obstruction in the community is one of the leading causes (if not the greatest cause) of death and disability in the civilized world today.

Many modifications are possible to the emergency system without departing from the spirit or innovative concept of the invention.

With regards to the Randomic Vibration source of preferred randomic vibrator 10, while the embodiment shown advantageously employs an electromechanical transducer comprising a linear stepper motor (such as to enable a high level of vibratory control and selectivity of frequency, displacement amplitude, duty factor, and vibratory displacement wave forms in non-randomic and randomic modes), alternatively any known (or adaptable) low frequency (i.e. 1-1000 Hz) randomic vibrator (or randomic percussion device, or randomic oscillation device by other name), with a suitable attachment interface for selected body surface contact (preferably enabling concentrated delivery of Randomic Vibration between the rib space or spaces of the patient 20), being operable at a displacement amplitude range of about 0.1-15 mm, and engagement forces of. >5-10 Newtons, and preferably>20 Newtons, may alternatively be used, regardless of the level of operator enabled Randomic Vibration control.

Also, while preferred randomic vibrator 10 comprises a hand held device sized to enable hand held operation, engagement and maneuverability, alternatively a Randomic Vibration source of comparable emission capacity may be fixed in place as part of a furniture item such as a chair or bed which could be particularly useful for Randomic Vibration to the backside of the patient 20, such as in treatment in acute myocardial cases, or to the posterior region of the head or neck of a patient, such as in treatment of acute ischemic stroke.

Furthermore, while the preferred embodiment (apparatus) discloses a single motor located within randomic vibrator 10, a pair or a plurality beyond a pair of motors may also be used (for example, one motor for each contact 12).

It should also be noted that there is effectively no definable maximal nor minimal limit to displacement amplitude range or engagement force applied in emergency Randomic Vibration therapy (i.e. the intensity emitted is generally a function of the tolerance of the patient 20 which will vary markedly). Any of the above variations to Randomic Vibration source may be therefore adapted in size and scale to enable Randomic Vibration at higher or conversely lower loads and displacement amplitudes than what is otherwise disclosed according to the invention. For example, while the preferred embodiment shown (i.e. randomic vibrator 10) provides a peak displacement amplitude of up to 15 mm, this enablement is generally in excess of what is typically required, and a device limited to lower peak displacement amplitudes (i.e. with an upper limit as low as about 4-8 mm), may alternatively be employed for transthoracic cardiac or pulmonary applications, and lower peak displacement amplitude levels of up to about 2 mm may be satisfactory for acute ischemic stroke applications. Lower peak displacement amplitude devices are potentially “safer” (i.e. as the “tolerance” level of the patient 20 may be difficult to judge at the time of treatment), and confer lighter weight more compact systems, which are generally easier to maneuver and operate by hand. In an exemplary alternative embodiment, the vibrator employed may be operable to the maximum displacement amplitudes allowable (i.e. deemed safe) under the officiating governmental regulatory body or bodies of the country wherein the vibrator is to be commercialized.

The nature of Randomic Vibration may also comprise variable orders or degrees of randomness, with by way of example a variety of ordered vibration algorithms (or non random vibratory patterns) applied in a random order. For example, one vibration algorithm with ever increasing frequency may be randomly followed by another vibration algorithm will alternating frequencies, which is then randomly followed by another vibration algorithm with only one fixed frequency.

With regards to the preferred attachment interface, while the embodiment shown incorporates a pair of contacts 12 spaced to enable bridging the sternum of patient 20, any other attachment interface suitable to enable human contact could potentially be used according to the invention, such as by way of example only; suction cups, a single contact 12, a plurality beyond a pair of contacts 12, and variant contacts enabling HFUS ultrasonic imaging with or without LFUS wave form emissions), which may be utilized solely, or in any combination, as per the methods described, to best suit the clinical situation and/or preference of the operator. An attachment interface comprising a LFUS transducer or more broadly a therapeutic actuator operable to emit oscillations in the 1 KHz-500 KHz range may also be employed without an ultrasonic imaging transducer or Doppler transducer.

It is also possible to utilize more than one Randomic Vibration device for placement to a plurality of locations along the body of the patient 20, such as to further ensure maximal penetration and effectiveness of Randomic Vibration therapy for acute vascular disturbances. In this alternative embodiment the Randomic Vibration devices should optimally be operated in phase to one another (i.e. to avoid potential destructive interference of the therapeutic signal). This technique may be of particular relevance wherein an imaging technique to direct Randomic Vibration therapy is not employed.

The disclosed “dual function” ultrasonic imaging system to direct (or target) Randomic Vibration therapy may also be embodied in a variety of ways. An ultrasonic imaging transducer for example may be placed side by side to a Randomic Vibration source, as apposed to end to end as disclosed in variant imaging Randomic Vibration device 15.

Also, while the preferred use for randomic vibrator 10 is for treatment of acute blood flow disorders such as coronary or cerebral thrombosis, randomic vibrator 10 potentially (or any variant thereof, as long as Randomic Vibration of any type is presented) has other uses such as for by way of example; angiogenesis (such as coronary angiogenesis), physiotherapeutic muscle massage, to mobilize pulmonary secretions in cystic fibrosis patients, and as a beauty tool.

Furthermore, while the preferred randomic vibrator 10 offers targeted localized vibration to a selected body region, alternatively in a variation a randomic vibrator may comprise a vibrating platform, a chair, or a stretcher or bed by which an individual or patient stands, sits or reclines. Randomic Vibration may in this variation of whole body vibration assist in generally improving blood flow to patients, and in the platform example can with enhanced efficiency serve as an excellent muscle stabilization/balance training tool for the leg and hip region. In this platform embodiment while vibration may fall anywhere in the range of 1-1000 cycles per second with a displacement amplitude of at least 0.1 mm, displacement amplitudes of at least 1 mm are preferred (and there is no maximum displacement amplitude emanating from the platform) such as to enable the provision of sufficient therapy to the muscle group targeted according to the needs and abilities of the individual using the platform. Frequencies between about 5 Hz-200 Hz are preferred in this platform embodiment. Random variation of the directivity (or angle of the platform) is a particularly useful form of muscle balancing and stabilization exercise.

In an alternative embodiment of the present invention, an altenative to Randomic Vibration for treatment of blood flow disorders (and particularly in treatment of blood flow disturbances such as acute coronary thrombosis or angina pectoris) is to “ramp” the vibration frequency, or “sweep” the vibration frequency—i.e. to cyclically vary the vibration frequency through the 1-1000 Hz range, preferably in the 1-200 Hz range, and most preferably in the 20-120 Hz range—(such as to match the resonance frequency range for the heart/heart muscle whereupon the coronary arteries are situated). In this alternative embodiment, similar to the use of Randomic Vibration, the cyclical variation or ramp/sweep of vibration frequency enables capture of a particular resonance frequency of the heart muscle which will vary according to individuals on a case to case basis. The ramped, or sweeped vibration frequency feature as herein described can be substituted for Randomic Vibration in any of the embodiments herein presented in the above disclosure. Alternatively, the ramping or sweeping (i.e. cyclical variation) of vibration frequency may be used in combination with Randomic Vibration in any of the above-disclosed embodiments, wherein one or more other vibration parameters are randomly varied while the vibration frequency is ramped/swept through a range.

As will be apparent to those skilled in the art in light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A therapeutic device for treatment of a blood flow disorder comprising a vibrator administrable to transmit a mechanical vibration characterized by one or more vibration parameters to an external human body surface, wherein at least one vibration parameter of said mechanical vibration is randomly varied over time.

2. The therapeutic device according to claim 1, wherein said one or more vibration parameters comprise at least one of: vibration frequency, vibration displacement amplitude, vibration force, vibration directivity, vibration wave shape, vibration duty factor, and vibration pattern.

3. A method for using the therapeutic device as defined in claim 1 for remediation of a blood flow disorder, comprising non-invasively applying said mechanical vibration from said vibrator locally upon a targeted external human body surface generally overlying a diseased vasculature responsible for said blood flow disorder, wherein at least one vibration parameter of said mechanical vibration is randomly varied over time.

4. The method of claim 3, wherein said one or more parameter of said mechanical vibration which is randomly varied over time comprises at least one of: vibration frequency, vibration displacement amplitude, vibration force, vibration directivity, vibration wave shape, vibration duty factor, and vibration pattern.
